(19) United States
(12) Patent Application Publication
(10) Pub. No.: US 2024/0215015 A1
(43) Pub. Date: Jun. 27, 2024

(54) Method and Apparatus for PUSCH Repetition in a Random Access Procedure

(71) Applicant: Telefonaktiebolaget LM Ericsson (publ), Stockholm (SE)

(72) Inventors: Ling Su, Beijing (CN); Zhipeng Lin, Nanjing Jiangsu (CN); Yuande Tan, Beijing (CN)

(21) Appl. No.: 18/019,305

(22) PCT Filed: Aug. 2, 2021
(86) PCT No.: PCT/CN2021/110118

§ 371 Date: Feb. 2, 2023

(30) Foreign Application Priority Data
Aug. 4, 2020 (WO) PCT/CN2020/106760
Jan. 11, 2021 (WO) PCT/CN2021/071143
Jan. 12, 2021 (WO) PCT/CN2021/071338
May 11, 2021 (WO) PCT/CN2021/093065

(51) Int. Cl. H04W 72/1268; H04L 5/14; H04W 72/232; H04W 74/0833

(52) U.S. Cl. CPC H04W 72/1268; H04L 5/1469; H04W 72/232; H04W 74/0833

(57) ABSTRACT

Various embodiments of the present disclosure provide methods and apparatuses for PUSCH repetition in a random access procedure. According to one embodiment, the method is implemented at a terminal device and comprises: receiving a configuration of repetition of physical uplink shared channel, PUSCH, transmission for a message in a random access procedure from a network node, and transmitting a PUSCH to the network node, based on the configuration of repetition of PUSCH transmission.

### FIELD OF THE INVENTION

The present disclosure generally relates to wireless communications, and more specifically, to methods and apparatuses for physical uplink shared channel (PUSCH) repetition in a random access (RA) procedure.

### BACKGROUND

This section introduces aspects that may facilitate a better understanding of the disclosure. Accordingly, the statements of this section are to be read in this light and are not to be understood as admissions about what is in the prior art or what is not in the prior art.

There are two types of RA procedure supported in NR, i.e., four-step RA type and two-step RA type. Both types of RA procedure support contention based random access (CBRA) and contention-free random access (CFRA).

FIG. 1 illustrate the four-step CBRA procedure which is used for connecting a user equipment (UE) to a network (e.g., gNB). In Step 1, the UE initiates the random access procedure by transmitting in uplink (UL) a random access preamble (i.e., Msg 1) on a physical random access channel (PRACH). After detecting the Msg1, the gNB will respond by transmitting in downlink (DL) a random-access response (RAR) (i.e., Msg2) on a physical downlink shared channel (PDSCH), in Step 2. In Step 3, after successfully decoding the Msg2, the UE continues the random access procedure by transmitting in UL a PUSCH message (i.e., Msg3) for terminal identification and RRC connection establishment request. This message is scheduled using a physical downlink control channel (PDCCH). In Step 4, the gNB transmits in DL a PDSCH message (i.e., Msg4) for contention resolution.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

The present disclosure proposes a solution of PUSCH repetition in the RA procedure. With the solution, PUSCH repetition can be supported to improve coverage of Msg3 transmission in the RA procedure.

According to a first aspect of the present disclosure, there is provided a method implemented at a terminal device. The method comprises receiving a configuration of repetition of physical uplink shared channel, PUSCH, transmission for a message in a random access procedure from a network node, and transmitting a PUSCH to the network node, based on the configuration of repetition of PUSCH transmission.

In accordance with an exemplary embodiment, the message may be a message 3 in a four-step random access procedure.

In accordance with an exemplary embodiment, the configuration of repetition of PUSCH transmission may be received in a random access response, RAR.

In accordance with an exemplary embodiment, the configuration of repetition of PUSCH transmission comprises a configured number of repetitions.

In accordance with an exemplary embodiment, the configured number of repetitions may be one of the followings: a specific number of repetitions, and a maximum number of repetitions.

In accordance with an exemplary embodiment, the configuration of repetition of PUSCH transmission may be received in system information.

In accordance with an exemplary embodiment, the configuration of repetition of PUSCH transmission may be indicated in PUSCH-ConfigCommon information element in system information block1, SIB1, or may be jointly encoded in a time domain resource allocation table in SIB1.

In accordance with an exemplary embodiment, the configuration of repetition of PUSCH transmission may comprise at least one of the followings: one or more candidate numbers of repetitions, a default number of repetitions, and a maximum number of repetitions.

In accordance with an exemplary embodiment, the configuration of repetition of PUSCH transmission may be received in downlink control information, DCI.

In accordance with an exemplary embodiment, the configuration of repetition of PUSCH transmission may comprise a specific number of repetitions or a maximum number of repetitions.

In accordance with an exemplary embodiment, the configuration of repetition of PUSCH transmission may comprise information related to determination of available slots for the repetition of PUSCH transmission.

In accordance with an exemplary embodiment, the information related to determination of available slots for the repetition of PUSCH transmission may indicate which slot is an available slot for the repetition, or indicate whether and which Time Division Duplexing, TDD, uplink downlink signaling is to be used for the determination of available slots.

In accordance with an exemplary embodiment, the information related to determination of available slots for the repetition of PUSCH transmission may be included in at least one of the followings: a cell specific TDD uplink downlink configuration, a random access response, RAR, and downlink control information, DCI.

In accordance with an exemplary embodiment, the available slot may be a slot not configured as a downlink slot, and/or a slot in which a set of symbols allocated for the repetition of PUSCH transmission is not configured as downlink, and/or a slot configured as an uplink slot, and/or a slot in which a set of symbols allocated for the repetition of PUSCH transmission is configured as uplink.

In accordance with an exemplary embodiment, the configuration of repetition of PUSCH transmission may further comprise priority information for collision handling between the repetition of PUSCH transmission and other uplink transmission from the terminal device.

In accordance with an exemplary embodiment, the priority information may be included in a higher layer configuration and/or DCI, and/or may be predetermined or predefined.

In accordance with an exemplary embodiment, the priority information may be based on a time order of scheduling signaling, or a content of uplink transmission, or a type of scheduling signaling.

In accordance with an exemplary embodiment, the collision handling may be based on the priority information received prior to transmission of the first repetition of PUSCH transmission.

In accordance with an exemplary embodiment, the collision handling may be further based on the priority information received during transmission of the repetitions of PUSCH transmission.

In accordance with an exemplary embodiment, transmitting the PUSCH to the network node based on the configuration of repetition of PUSCH transmission may comprise determining a number of repetitions to be used for the PUSCH transmission based on the configuration of repetition of PUSCH transmission, and transmitting the PUSCH based on the determined number of repetitions.

In accordance with an exemplary embodiment, the configuration of repetition of PUSCH transmission may be received in the RAR or DCI. In an embodiment, determining a number of repetitions to be used for the PUSCH transmission may comprise, when the configuration of repetition of PUSCH transmission comprises the specific number of repetitions, determining the number of repetitions to be the specific number of repetitions, and/or when the configuration of repetition of PUSCH transmission comprises the maximum number of repetitions, determining the number of repetitions to be a number not more than the maximum number of repetitions.

In accordance with an exemplary embodiment, the configuration of repetition of PUSCH transmission may be received in the system information and not received in the RAR or DCI. In an embodiment, determining a number of repetitions to be used for the PUSCH transmission may comprise, when the configuration of repetitions of PUSCH transmission comprises only one or more candidate number of repetitions, choosing a candidate number of repetitions from the one or more candidate numbers of repetitions, as the number of repetitions to be used for the PUSCH transmission; and/or when the configuration of repetitions of PUSCH transmission comprises the default number of repetitions or both the default number of repetitions and the maximum number of repetition, determining the number of repetitions to be the default number of repetition; and/or when the configuration of repetitions of PUSCH transmission comprises the maximum number of repetitions, determining the number of repetitions to be a number not more than the maximum number of repetitions.

In accordance with an exemplary embodiment, when the configuration of repetition of PUSCH transmission is jointly encoded in a time domain resource allocation table in SIB1, an entry of the time domain resource allocation table may be received in the RAR or DCI. Further, the number of repetitions to be used for the PUSCH transmission may be determined based on the entry.

In accordance with an exemplary embodiment, transmitting the PUSCH to the network node based on the configuration of repetition of PUSCH transmission may further comprise determining respective available slots for the number of repetitions, based on the information related to determination of available slots for the repetition of PUSCH transmission included in the configuration of repetition of PUSCH transmission. Further, the PUSCH may be transmitted in the respective available slots.

In accordance with an exemplary embodiment, the random access procedure may be contention based random access, CBRA, and the available slots may be determined based on a cell specific TDD uplink downlink configuration.

In accordance with an exemplary embodiment, the random access procedure may be contention free random access, CFRA, and the available slots may be determined based on a dedicated TDD uplink downlink configuration and/or a cell specific TDD uplink downlink configuration.

In accordance with an exemplary embodiment, the available slots may be determined further based on collision with other uplink transmission from the terminal device and/or a cancellation indication.

In accordance with an exemplary embodiment, an available slot may be determined as unavailable if at least one of a set of symbols allocated for the repetition of PUSCH transmission in that available slot overlaps with a symbol not intended for an uplink transmission.

In accordance with an exemplary embodiment, the available slots may be determined prior to transmission of the first repetition of PUSCH transmission and/or during transmission of the repetitions of PUSCH transmission.

In accordance with an exemplary embodiment, redundancy versions for the repetitions of PUSCH transmission may be cycled across the determined available slots.

In accordance with an exemplary embodiment, redundancy versions for the repetitions of PUSCH transmission may be cycled across the transmitted repetitions of PUSCH transmission.

In accordance with an exemplary embodiment, transmitting the PUSCH may comprise determining one or more slots among K slots from a first slot for the repetitions to be used for repetitions of PUSCH transmission, wherein K represents the determined number of repetitions; for each slot of the K slots in which all Z scheduled uplink, UL, symbols for PUSCH transmission are available, transmitting a repetition by configuring the L scheduled UL symbols and placing demodulation reference signal, DMRS, in the slot; and/or for each slot in which part of the L scheduled UL symbols is available of the K slots, when a number of the available UL symbols is not less than a first threshold, performing a symbol-wise repetition from a particular repetition which has the L scheduled UL symbols available on the available UL symbols and placing DMRS in the slot; and/or when the number of the available UL symbols is less than the first threshold, not using the slot to transmit the PUSCH.

In accordance with an exemplary embodiment, transmitting the PUSCH may comprise, for a slot from a first slot for repetitions of PUSCH transmission, when all L scheduled UL symbols for PUSCH transmission are available, transmitting a repetition by configuring the L scheduled UL symbols and placing DMRS in the slot and incrementing a slot counter; and/or when part of the L scheduled UL symbols is available, when a number of the available UL symbols is not less than a first threshold, performing a symbol-wise repetition from a particular repetition which has the L scheduled UL symbols available on the available UL symbols and placing DMRS in the slot, and/or when the number of the available UL symbols is less than the first threshold, not using the slot to transmit the PUSCH; and repeating the above operations for a next slot until the slot counter reaches the determined number of repetitions.

In accordance with an exemplary embodiment, the placement of the DMRS in the slot may be configured or predefined.

In accordance with an exemplary embodiment, the particular repetition may be determined further based on redundancy version cycling.

In accordance with an exemplary embodiment, the first threshold may be transmitted via radio resource control, RRC, signaling or downlink control information, DCI, or the first threshold may be predefined.

In accordance with an exemplary embodiment, the slots for the repetitions of PUSCH transmission may be contiguous or non-contiguous within one radio frame or across frame border.

In accordance with an exemplary embodiment, the method may further comprise transmitting a capability report indicating a capability of keeping phase coherency across multiple slots to the network node.

In accordance with an exemplary embodiment, transmitting the PUSCH may further comprise: for each of the slots for the repetitions of PUSCH transmission, checking whether a dynamic slot format indicator is configured for the slot; in response to the dynamic slot format indicator being not configured, determining whether semi-static flexible symbols are available for PUSCH transmission; and/or in response to the dynamic slot format indicator being configured, determining whether semi-static flexible symbols are changed as DL symbols, and determining the semi-static flexible symbols changed as the DL symbols are unavailable for PUSCH transmission.

In accordance with an exemplary embodiment, transmitting the PUSCH may further comprise, for each slot of the slots in which part of the Z scheduled UL symbols is available, applying frequency hopping to the repetition in the slot when the number of the available UL symbols of the L scheduled UL symbols is not less than a second threshold; and/or applying no frequency hopping to the repetition in the slot when the number of the available UL symbols of the L scheduled UL symbols is less than the second threshold.

In accordance with an exemplary embodiment, a DMRS configuration for the DMRS may be determined based on at least one of application of repetition to PUSCH transmission and the number of repetitions to be used for the PUSCH transmission.

In accordance with an exemplary embodiment, a mapping between application of repetition and DMRS configurations and a mapping between numbers of repetitions and DMRS configurations may be configured or predefined.

In accordance with an exemplary embodiment, the application of repetition may be mapped to at least one of the followings in the DMRS configuration: a DMRS port, a code division multiplexing, CDM, group, a DMRS configuration type, usage of an additional DMRS symbol, and a DMRS sequence.

In accordance with an exemplary embodiment, the number of repetitions may be mapped to at least one of the followings in the DMRS configuration: a DMRS port, a DMRS configuration type, a CDM group, and a DMRS sequence.

In accordance with an exemplary embodiment, the method may further comprise transmitting a physical random access channel, PRACH, message to the network node, wherein the PRACH message indicates a capability of PUSCH repetition of the terminal device.

In accordance with an exemplary embodiment, the capability of PUSCH repetition may be indicated by a random access, RA, preamble or a PRACH occasion used in the PRACH message.

In accordance with an exemplary embodiment, the method may further comprise receiving system information indicating a plurality of RA preamble groups and one or more of the plurality of RA preamble groups to be used for a terminal device capable of supporting PUSCH repetition.

In accordance with an exemplary embodiment, the plurality of RA preamble groups may comprise RA preamble group A and RA preamble group B, and the RA preamble group B may be configured to be used for a terminal device capable of supporting PUSCH repetition.

In accordance with an exemplary embodiment, the plurality of RA preamble groups may comprise RA preamble group A, RA preamble group B and RA preamble group C, and the RA preamble group C may be configured to be used for a terminal device capable of supporting PUSCH repetition.

In accordance with an exemplary embodiment, the RA preamble group C may comprise a subset of contention-free random access preambles and may be configured as contention based random access preambles.

In accordance with an exemplary embodiment, the RA preamble group C may comprise beginning contention-free random access preambles or middle contention-free random access preambles or ending contention-free random access preambles.

In accordance with an exemplary embodiment, transmitting the PRACH message may comprise determining an RA preamble group from the plurality of RA preamble groups based on the capability of PUSCH repetitions of the terminal device, selecting an RA preamble from the determined RA preamble group, and transmitting the RA preamble to the network node.

In accordance with an exemplary embodiment, the RA preamble group C may comprise RA preamble group C1 and RA preamble group C2.

In accordance with an exemplary embodiment, transmitting the PRACH message may comprise determining an RA preamble group from the plurality of RA preamble groups based on the capability of PUSCH repetitions of the terminal device, in response to the determined RA preamble group being the RA preamble group C, determining whether a condition is satisfied, in response to the condition being satisfied, selecting the RA preamble group C1 and selecting an RA preamble from the RA preamble group C1; and/or in response to the condition being not satisfied, selecting the RA preamble group C2 and selecting an RA preamble from the RA preamble group C2; and transmitting the RA preamble to the network node.

In accordance with an exemplary embodiment, the condition may be at least one of the followings:
1) a size of the PUSCH transmission is below a third threshold;
2) a recommended number of repetitions is equal to or below a fourth threshold;
3) reference signal received power, RSRP, is below a fifth threshold;
4) the terminal device is in poor coverage or a cell border area; and
5) a camped synchronization signal/physical broadcast channel block, SSB, index is not the best SSB index.

In accordance with an exemplary embodiment, the RA preamble group C may further comprise RA preamble group C3.

In accordance with an exemplary embodiment, when the terminal device cannot determine whether the condition is satisfied, the RA preamble group C3 may be selected, and a RA preamble may be selected from the RA preamble group C3.

In accordance with an exemplary embodiment, the method may further comprise receiving system information indicating one or more physical random access channel, PRACH, occasions to be used for a terminal device capable of supporting PUSCH repetition.

In accordance with an exemplary embodiment, the one or more PRACH occasions may be separately configured for the terminal device capable of supporting PUSCH repetition.

In accordance with an exemplary embodiment, transmitting the PRACH message may comprises determining a PRACH occasion based on the capability of PUSCH repetition of the terminal device, determining an RA preamble, and transmitting the RA preamble in the PRACH occasion to the network node.

In accordance with an exemplary embodiment, a random access type may be determined to be used for a terminal device capable of supporting PUSCH repetition.

In accordance with an exemplary embodiment, transmitting the PRACH message may comprise determining a random access type based on the capability of PUSCH repetition of the terminal device and transmitting the PRACH message according to the random access type.

According to a second aspect of the present disclosure, there is provided a method implemented at a network node. The method comprises transmitting a configuration of repetition of a physical uplink shared channel, PUSCH, transmission for a message in a random access procedure to a terminal device, and receiving a PUSCH from the terminal device.

In accordance with an exemplary embodiment, the message may be a message 3 in a four-step random access procedure.

In accordance with an exemplary embodiment, the configuration of repetition of PUSCH transmission may be transmitted in a random access response, RAR.

In accordance with an exemplary embodiment, the configuration of repetition of PUSCH transmission may comprise a configured number of repetitions.

In accordance with an exemplary embodiment, the configured number of repetitions may be one of the followings: a specific number of repetitions, and a maximum number of repetitions.

In accordance with an exemplary embodiment, the configuration of repetition of PUSCH transmission may be transmitted in system information.

In accordance with an exemplary embodiment, the configuration of repetition of PUSCH transmission may be indicated in PUSCH-ConfigCommon information element in system information block1, SIB1, or may be jointly encoded in a time domain resource allocation table in SIB1.

In accordance with an exemplary embodiment, the configuration of repetition of PUSCH transmission may comprise at least one of the followings: one or more candidate numbers of repetitions, a default number of repetitions, and a maximum number of repetitions.

In accordance with an exemplary embodiment, the configuration of repetition of PUSCH transmission may be transmitted in downlink control information, DCI.

In accordance with an exemplary embodiment, the configuration of repetition of PUSCH transmission may comprise a specific number of repetitions or a maximum number of repetitions.

In accordance with an exemplary embodiment, when the configuration of repetition of PUSCH transmission is jointly encoded in a time domain resource allocation table in SIB1, an entry of the time domain resource allocation table may be transmitted in the RAR or DCI.

In accordance with an exemplary embodiment, the configuration of repetition of PUSCH transmission may comprise information related to determination of available slots for the repetition of PUSCH transmission.

In accordance with an exemplary embodiment, the information related to determination of available slots for the repetition of PUSCH transmission may indicate which slot is an available slot for the repetition, or indicate whether and which Time Division Duplexing, TDD, uplink downlink signaling is to be used for the determination of available slots.

In accordance with an exemplary embodiment, the information related to determination of available slots for the repetition of PUSCH transmission may be included in at least one of the followings: a cell specific TDD uplink downlink configuration, a random access response, RAR, and downlink control information, DCI.

In accordance with an exemplary embodiment, the available slot may be a slot not configured as a downlink slot, and/or a slot in which a set of symbols allocated for the repetition of PUSCH transmission is not configured as downlink, and/or a slot configured as an uplink slot, and/or a slot in which a set of symbols allocated for the repetition of PUSCH transmission is configured as uplink.

In accordance with an exemplary embodiment, the configuration of repetition of PUSCH transmission may further comprise priority information for collision handling between the repetition of PUSCH transmission and other uplink transmission from the terminal device.

In accordance with an exemplary embodiment, the priority information may be included in a higher layer configuration and/or DCI, and/or may be predetermined or predefined.

In accordance with an exemplary embodiment, the priority information may be based on a time order of scheduling signaling, or a content of uplink transmission, or a type of scheduling signaling.

In accordance with an exemplary embodiment, redundancy versions for the repetitions of PUSCH transmission may be cycled across the determined available slots.

In accordance with an exemplary embodiment, redundancy versions for the repetitions of PUSCH transmission may be cycled across the transmitted repetitions of PUSCH transmission.

In accordance with an exemplary embodiment, receiving the PUSCH from the terminal device may comprise determining whether repetition is applied to the PUSCH transmission based on a demodulation reference signal, DMRS, configuration used for PUSCH transmission; and in response to determining that the repetition is applied to the PUSCH transmission, when a number of repetitions used by the terminal device for the PUSCH transmission is known to the network node, decoding the PUSCH transmission with the number of repetitions, and/or when the number of Msg3 repetitions used by the terminal device for the PUSCH transmission is not known to the network node, blindly decoding the PUSCH transmission with repetition, and/or in response to determining that the repetition is not applied to the PUSCH transmission, decoding the PUSCH transmission without repetition.

In accordance with an exemplary embodiment, the determination of whether repetition is applied to the PUSCH transmission may be based on at least one of the followings in the DMRS configuration: a DMRS port, a code division multiplexing, CDM, group, a DMRS configuration type, usage of an additional DMRS symbol, and a DMRS sequence.

In accordance with an exemplary embodiment, a mapping between application of repetition and DMRS configurations may be configured or predefined.

In accordance with an exemplary embodiment, when the number of repetitions used by the terminal device for the PUSCH transmission is not known to the network node, receiving the PUSCH from the terminal device may further comprise determining the number of repetitions used by the terminal device for the PUSCH transmission based on the DMRS configuration.

In accordance with an exemplary embodiment, the determination of the number of repetitions may be based on at least one of the followings in the DMRS configuration: a DMRS port, a DMRS configuration type, a CDM group, and a DMRS sequence.

In accordance with an exemplary embodiment, a mapping between numbers of repetitions and DMRS configurations may be configured or predefined.

In accordance with an exemplary embodiment, the method may further comprise receiving a PRACH message from the terminal device, wherein the PRACH message indicates whether a capability of PUSCH repetition of the terminal device is indicated.

In accordance with an exemplary embodiment, the capability of PUSCH repetition may be indicated by a random access, RA, preamble or a PRACH occasion used in the PRACH message.

In accordance with an exemplary embodiment, transmitting a configuration of repetition of PUSCH transmission may comprises determining whether the capability of PUSCH repetition of the terminal device is indicated based on the PRACH message, when the capability of PUSCH repetition of the terminal device indicates that the terminal device is capable of supporting PUSCH repetition, configuring the number of repetitions for the terminal device based on the capability of PUSCH repetition of the terminal device; and/or when the capability of PUSCH repetition of the terminal device indicates that the terminal device is incapable of supporting PUSCH repetition, not configuring the number of repetitions for the terminal device; and/or when the capability of PUSCH repetition of the terminal device is not indicated, blindly configuring the number of repetitions for the terminal device; and transmitting the configuration of repetition comprising the configured number of repetitions.

In accordance with an exemplary embodiment, the method may further comprise transmitting system information indicating a plurality of RA preamble groups and one or more of the plurality of RA preamble groups to be used for a terminal device capable of supporting PUSCH repetition.

In accordance with an exemplary embodiment, the plurality of RA preamble groups may comprise RA preamble group A and RA preamble group B, and the RA preamble group B may be configured to be used for a terminal device capable of supporting PUSCH repetition.

In accordance with an exemplary embodiment, the plurality of RA preamble groups may comprise RA preamble group A, RA preamble group B and RA preamble group C, and the RA preamble group C may be configured to be used for a terminal device capable of supporting PUSCH repetition.

In accordance with an exemplary embodiment, the RA preamble group C may comprise a subset of contention-free random access preambles and may be configured as contention based random access preambles.

In accordance with an exemplary embodiment, the RA preamble group C may comprise beginning contention-free random access preambles or middle contention-free random access preambles or ending contention-free random access preambles.

In accordance with an exemplary embodiment, the RA preamble group C may comprise RA preamble group C1 further configured to be used for a terminal device satisfying a condition and RA preamble group C2 further configured to be used for a terminal device not satisfying the condition.

In accordance with an exemplary embodiment, the RA preamble group C may further comprise RA preamble group C3 further configured to be used for a terminal device which does not determine whether the condition is satisfied.

In accordance with an exemplary embodiment, the condition may be one of the followings:
1) a size of the PUSCH transmission is below a third threshold;
2) a recommended number of repetitions is equal to or below a fourth threshold;
3) reference signal received power, RSRP, is below a fifth threshold;
4) the terminal device is in poor coverage or a cell border area; and
5) a camped synchronization signal/physical broadcast channel block, SSB, index is not the best SSB index.

In accordance with an exemplary embodiment, determining whether the capability of PUSCH repetition of the terminal device is indicated based on the PRACH message may comprise obtaining a random access, RA, preamble in PRACH message, determining an RA preamble group associated with the RA preamble, and determining whether the capability of PUSCH repetition of the terminal device is indicated based on the determined RA preamble group.

In accordance with an exemplary embodiment, the method may further comprise transmitting system information indicating one or more physical random access channel, PRACH, occasions to be used for a terminal device capable of supporting PUSCH repetition.

In accordance with an exemplary embodiment, the one or more PRACH occasions may be separately configured for the terminal device capable of supporting PUSCH repetition.

In accordance with an exemplary embodiment, determining whether the capability of PUSCH repetition of the terminal device is indicated based on the PRACH message may comprise determining a PRACH occasion in which an RA preamble is transmitted, and determining whether the capability of Msg3 repetition of the terminal device is indicated based on the determined PRACH occasion.

In accordance with an exemplary embodiment, a random access type may be determined to be used for a terminal device capable of supporting PUSCH repetition.

In accordance with an exemplary embodiment, determining whether the capability of PUSCH repetition of the terminal device is indicated based on the PRACH message may comprises determining a random access type based on an RA preamble transmitted in the PRACH message, and determining whether the capability of PUSCH repetition of the terminal device is indicated based on the random access type.

According to a third aspect of the present disclosure, there is provided a terminal device. The terminal device may comprise one or more processors and one or more memories comprising computer program codes. The one or more memories and the computer program codes may be configured to, with the one or more processors, cause the terminal device at least to perform any step of the method according to the first aspect of the present disclosure.

According to a fourth aspect of the present disclosure, there is provided a computer-readable medium having computer program codes embodied thereon which, when executed on a computer, cause the computer to perform any step of the method according to the first aspect of the present disclosure.

According to a fifth aspect of the present disclosure, there is provided a network node. The network node may comprise one or more processors and one or more memories comprising computer program codes. The one or more memories and the computer program codes may be configured to, with the one or more processors, cause the network node at least to perform any step of the method according to the second aspect of the present disclosure.

According to a sixth aspect of the present disclosure, there is provided a computer-readable medium having computer program codes embodied thereon which, when executed on a computer, cause the computer to perform any step of the method according to the second aspect of the present disclosure.

According to a seventh aspect of the present disclosure, there is provided a terminal device. The terminal device comprises a receiving unit configured to receive a configuration of repetition of physical uplink shared channel, PUSCH, transmission for a message in a random access procedure from a network node and a transmitting unit configured to transmit a PUSCH to the network node, based on the configuration of repetition of PUSCH transmission.

According to an eighth aspect of the present disclosure, there is provided a network node. The network node comprises a transmitting unit configured to transmit a configuration of repetition of physical uplink shared channel, PUSCH, transmission for a message in a random access procedure to a terminal device and a receiving unit configured to receive a PUSCH from the terminal device.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a diagram illustrating a four-step random access procedure;

FIG. 2 is a diagram illustrating DMRS configuration types in frequency domain;

FIG. 3A is a diagram illustrating an example of Msg3 repetition according to some embodiments of the present disclosure;

FIG. 3B is a diagram illustrating another example of Msg3 repetition according to some embodiments of the present disclosure;

FIG. 4 is a diagram illustrating yet another example of Msg3 repetition according to some embodiments of the present disclosure;

FIG. 5 is a flowchart illustrating a random access procedure with Msg3 repetition according to some embodiments of the present disclosure;

FIG. 6A is a diagram illustrating RA preamble partitioning according to some embodiments of the present disclosure;

FIG. 6B is a diagram illustrating PRACH occasion partitioning according to some embodiments of the present disclosure;

FIG. 7 is a diagram illustrating an example of 1 SSB per PRACH occasion according to some embodiments of the present disclosure;

FIG. 8 is a flowchart illustrating a method implemented at a terminal device in a communication network according to some embodiments of the present disclosure;

FIG. 9 is a flowchart illustrating a method implemented at a network node in a communication network according to some embodiments of the present disclosure;

FIG. 10 is a block diagram illustrating an apparatus according to some embodiments of the present disclosure;

FIG. 11 is a block diagram illustrating an apparatus according to some embodiments of the present disclosure;

FIG. 12 is a block diagram illustrating an apparatus according to some embodiments of the present disclosure;

FIG. 13 is a block diagram illustrating a telecommunication network connected via an intermediate network to a host computer in accordance with some embodiments of the present disclosure;

FIG. 14 is a block diagram illustrating a host computer communicating via a base station with a UE over a partially wireless connection in accordance with some embodiments of the present disclosure;

FIG. 15 is a flowchart illustrating a method implemented in a communication system, in accordance with an embodiment of the present disclosure;

FIG. 16 is a flowchart illustrating a method implemented in a communication system, in accordance with an embodiment of the present disclosure;

FIG. 17 is a flowchart illustrating a method implemented in a communication system, in accordance with an embodiment of the present disclosure; and

FIG. 18 is a flowchart illustrating a method implemented in a communication system, in accordance with an embodiment of the present disclosure.

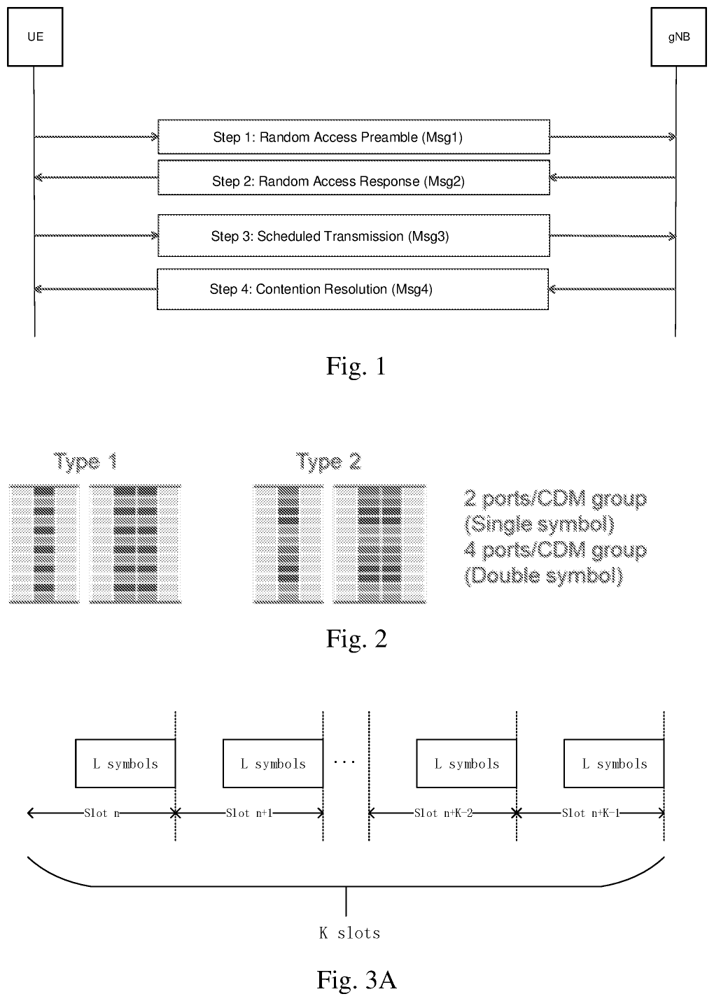

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the communication network and receives services therefrom. The network node or network device may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), an IAB node, a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g., refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

PUSCH repetition in NR release 15 and release 16 is described below.

Slot aggregation for PUSCH is supported in Release 15 and renamed to PUSCH repetition Type A in Release 16. The name PUSCH repetition Type A is used even if there is only a single repetition, i.e., no slot aggregation. In Release 15, a PUSCH transmission that overlaps with DL symbols is not transmitted.

For DCI granted multi-slot transmission (PDSCH/PUSCH) vs semi-static DL/UL assignment,
If semi-static DL/UL assignment configuration of a slot has no direction confliction with scheduled PDSCH/PUSCH assigned symbols, the PDSCH/PUSCH in that slot is received/transmitted;
If semi-static DL/UL assignment configuration of a slot has direction confliction with scheduled PDSCH/PUSCH assigned symbols, the PDSCH/PUSCH transmission in that slot is not received/transmitted, i.e. the effective number of repetitions reduces.

In Release 15, a number of repetitions is semi-statically configured by RRC parameter pusch-AggregationFactor. At most eight repetitions are supported as below.
pusch-AggregationFactor ENUMERATED {n2, n4, n8}

Early termination of PUSCH repetitions was discussed in Release 14 NR SI in RAN1 #88 with below agreement, but not standardized finally.

Agreements:

For UE configured with K repetitions for a transport block (TB) transmission with/without grant, the UE can continue repetitions (FFS can be different redundancy version (RV), FFS different modulation and coding scheme (MCS)) for the TB until one of the following conditions is met:
If an uplink (UL) grant is successfully received for a slot/mini-slot for the same TB
   FFS: How to determine the grant is for the same TB
FFS: An acknowledgement/indication of successful receiving of that TB from gNB
The number of repetitions for that TB reaches K
FFS: Whether it is possible to determine if the grant is for the same TB
Note that this does not assume that UL grant is scheduled based on the slot whereas grant free allocation is based on mini-slot (vice versa)
Note that other termination condition of repetition may apply

A new repetition format PUSCH repetition Type B is supported in Release 16, which PUSCH repetition allows back-to-back repetition of PUSCH transmissions. The biggest difference between the two types is that PUSCH repetition Type A only allows a single repetition in each slot, with each repetition occupying the same symbols. Using this format with a PUSCH length shorter than 14 symbols introduces gaps between repetitions, increasing the overall latency. The other change compared to Release 15 is how the number of repetitions is signaled. In Release 15, the number of repetitions is semi-statically configured, while in Release 16 the number of repetitions can be indicated dynamically in downlink control information (DCI). This applies to both dynamic grants and configured grants type 2.

In NR Release 16, invalid symbols for PUSCH repetition Type B include reserved UL resources. An invalid symbol pattern indicator field is configured in the scheduling DCI. Segmentation occurs around symbols that are indicated as downlink (DL) by the semi-static time division duplex (TDD) pattern and invalid symbols.

Below shows the signaling of the number of repetitions.

In TS38.214 V16.2.0:

For PUSCH repetition Type A, when transmitting PUSCH scheduled by DCI format 0_1 or 0_2 in PDCCH with cyclic redundancy check (CRC) scrambled with C-RNTI, MCS-C-RNTI, or CS-RNTI with NDI=1, the number of repetitions K is determined as:
if numberofrepetitions is present in a resource allocation table, the number of repetitions K is equal to numberofrepetitions;
else if the UE is configured with pusch-AggregationFactor, the number of repetitions K is equal to pusch-AggregationFactor;
otherwise K=1.

Format DCI0_1 is defined in TS38.212 V16.1.0:

Time domain resource assignment—0, 1, 2, 3, 4, 5, or 6 bits

If the higher layer parameter PUSCH-TimeDomainResourceAllocationList-ForDCIformat0_1 is not configured and if the higher layer parameter pusch-TimeDomainAllocationList is configured, 0, 1, 2, 3, or 4 bits as defined in Clause 6.1.2.1 of section 6, TS38.214 V16.3.0. The bitwidth for this field is determined as [log₂(I)] bits, where I is the number of entries in the higher layer parameter pusch-TimeDomainAllocationList or pusch-Time DomainAllocationList-r16;
If the higher layer parameter PUSCH-TimeDomainResourceAllocationList-ForDCIformat0_1 is configured, 0, 1, 2, 3, 4, 5 or 6 bits as defined in Clause 6.1.2.1 of section 6, TS38.214 V16.3.0. The bitwidth for this field is determined as [log₂(I)] bits, where I is the number of entries in the higher layer parameter PUSCH-TimeDomainResourceAllocationList-ForDCIformat0_1;
Otherwise, the bitwidth for this field is determined as [log₂(I)] bits, where I is the number of entries in the default table.

PUSCH-Config information element is defined in TS38.331 V16.1.0 as below.

PUSCH-Config information element

| | |
|---|---|
| pusch-TimeDomainAllocationList | SetupRelease { PUSCH-TimeDomainResourceAllocationList } |
| pusch-AggregationFactor | ENUMERATED { n2, n4, n8 } |

OPTIONAL, -- Need S
pusch-TimeDomainAllocationListForDCI-Format0-1-r16 SetupRelease { PUSCH-
TimeDomainResourceAllocationList-r16 }
pusch-TimeDomainAllocationListForDCI-Format0-2-r16 SetupRelease { PUSCH-
TimeDomainResourceAllocationList-r16 }

PUSCH-Config information element defines pusch-TimeDomainAllocationList, pusch-AggreationFactor, and pusch-TimeDomainAllocationListForDCI-Format0-1-r16.

PUSCH-TimeDomainResourceAllocation information element is defined in TS38.331 V16.1.0 as below.

PUSCH-TimeDomainResourceAllocation information element

[symbol]

ASN1START

[symbol]

PUSCH-TimeDomainResourceAllocationList ::= SEQUENCE (SIZE(1..maxNrofUL-Allocations)) OF
PUSCH-TimeDomainResourceAllocation
PUSCH-TimeDomainResourceAllocation ::= SEQUENCE {

| | |
|---|---|
| k2 | INTEGER(0..32) |

OPTIONAL, [symbol] Need S

| | |
|---|---|
| mappingType | ENUMERATED {typeA, typeB}, |
| startSymbolAndLength | INTEGER (0..127) |

}
PUSCH-TimeDomainResourceAllocationList-r16 ::= SEQUENCE (SIZE (1..maxNrofUL-Allocations-r16))
OF PUSCH-TimeDomainResourceAllocation-r16
PUSCH-TimeDomainResourceAllocation-r16 ::= SEQUENCE {

| | | |
|---|---|---|
| k2-r16 | INTEGER(0..32) | OPTIONAL, [symbol] |

| | |
|---|---|
| puschAllocationList-r16 | SEQUENCE (SIZE(1..maxNrofMultiplePUSCHs-r16)) |

OF PUSCH-Allocation-r16,
...
}
PUSCH-Allocation-r16 ::= SEQUENCE {

| | |
|---|---|
| mappingType-r16 | ENUMERATED {typeA, typeB} |

OPTIONAL, [symbol] Cond

[symbol]

| | |
|---|---|
| startSymbolAndLength-r16 | INTEGER (0..127) |

OPTIONAL, [symbol] Cond

[symbol]

| | |
|---|---|
| startSymbol-r16 | INTEGER (0..13) |

OPTIONAL, [symbol] Cond

[symbol]

| | |
|---|---|
| length-r16 | INTEGER (1..14) |

OPTIONAL, [symbol] Cond

[symbol]

| | |
|---|---|
| numberOfRepetitions-r16 | ENUMERATED {n1, n2, n3, n4, n7, n8, n12, n16} |

OPTIONAL, [symbol] Cond Formt01-02
...
}

[symbol]

[symbol]

ASN1STOP

| | | |
|---|---|---|
| maxNrofUL-Allocations | INTEGER ::= 16 | [symbol] Maximum number of PUSCH time |

domain resource allocations

[symbol]

| | | |
|---|---|---|
| maxNrofUL-Allocations-r16 | INTEGER ::= 64 | [symbol] Maximum number of PUSCH time |

[symbol]

indicates data missing or illegible when filed

It can be seen that PUSCH-TimeDomainResourceAllocation information element defines PUSCH-TimeDomainResourceAllocationList and numberOfRepetitions-r16.

Preamble group selection is described below.

It can be helpful for the network to have some rough estimate of the channel conditions the UE experiences and the available power the UE has to transmit random access messages as early as possible when radio links are being set up. In the four-step random access procedure in the 3GPP medium access control (MAC) specification 36.321 rev. 16.0.0, the UE will select Random Access Preambles group based on Msg3 size, logical channel and pathloss. The group that the UE selects its preamble from thereby provides an estimate of whether the UE has sufficient power to transmit Msg3. The preamble group selection is based on the configuration of Random Access Preambles group B, and ra-Msg3SizeGroupA:

2> else if Msg3 buffer is empty:
3> if Random Access Preambles group B is configured:

| | |
|---|---|
| 4> | if the potential Msg3 size (UL data available for transmission plus MAC header and, |
| | where required, MAC CEs) is greater than ra-Msg3SizeGroupA and the pathloss is less |
| | than PCMAX (of the Serving Cell performing the Random Access Procedure) - |
| | preambleReceivedTargetPower - msg3-DeltaPreamble - |
| | messagePowerOffsetGroupB; or |
| 4> | if the Random Access procedure was initiated for the CCCH logical channel and the |
| | CCCH SDU size plus MAC subheader is greater than ra-Msg3SizeGroupA: |
| | 5> select the Random Access Preambles group B. |

4> else:

5> select the Random Access Preambles group A.

```
  3> else:
    4> select the Random Access Preambles group A.
2> else (i.e. Msg3 is being retransmitted):
  3> select the same group of Random Access Preambles as was used for the Random Access
    Preamble transmission attempt corresponding to the first transmission of Msg3.
```

Where the parameters groupBconfigured (indicating if Random Access Preambles group B is configured) and ra-Msg3SizeGroupA are given in RACH-ConfigCommon information element while preambleReceivedTargetPower is found in RACH-ConfigGeneric information element.

UL grant in RAR in LTE is described below.

In LTE, the Uplink Grant field in RAR, also referred to as random access response grant field, indicates the resources to be used on the uplink. The size of the UL Grant field is 20 bits for UEs that do not have restricted bandwidth or coverage extension capability (‘Non-BL/CE UEs’). The content of these 20 bits starting with the MSB and ending with the LSB are as follows. It may be observed that the RAR indicates a number of Msg3 repetitions. Hopping flag—1 bit. Fixed size resource block assignment—10 bits. Truncated modulation and coding scheme—4 bits. If a UE is configured with a higher layer parameter pusch-EnhancementsConfig, then Repetition number of Msg3—3 bits, else TPC command for scheduled PUSCH—3 bits. UL delay—1 bit. CSI request—1 bit.

UL grant in RAR in LTE is described below.

4 bits are assigned for Msg3 time resource allocation, which is associated with pusch-TimeDomainAllocationList provided in pusch-ConfigCommon information element.

Random Access Response Grant Content field size is shown in Table 8.2-1 in TS38.213 V16.1.0 as below:

TABLE 8.2-1
Random Access Response Grant Content field size

| RAR grant field | Number of bits |
|---|---|
| Frequency hopping flag | 1 |
| PUSCH frequency resource allocation | 14, for operation without shared spectrum channel access |
| | 12, for operation with shared spectrum channel access |
| PUSCH time resource allocation | 4 |
| MCS | 4 |
| TPC command for PUSCH | 3 |
| CSI request | 1 |
| ChannelAccess-CPext | 0, for operation without shared spectrum channel access |
| | 2, for operation with shared spectrum channel access |

Table 6.1.2.1.1-1 in TS38.214 V16.3.0 lists applicable PUSCH time domain resource allocation for common search space and DCI format 0_0 in UE specific search space as below:

TABLE 6.1.2.1.1-1
Applicable PUSCH time domain resource allocation for common
search space and DCI format 0_0 in UE specific search space

| | | | | |
|---|---|---|---|---|
| | PDCCH | pusch-ConfigCommon | pusch-Config includes | PUSCH time domain |
| | search | includes pusch- | pusch- | resource allocation |
| RNTI | space | TimeDomainAllocationList | TimeDomainAllocationList | to apply |

| | | | |
|---|---|---|---|
| PUSCH scheduled by | No | — | Default A |
| MAC RAR as described | Yes | | pusch- |
| in clause 8.2 of [6, TS | | | TimeDomainAllocationList |
| 38.213] or MAC fallback | | | provided in pusch- |
| RAR as described in | | | ConfigCommon |
| clause 8.2A of [6, | | | |
| 38.213] or for MsgA | | | |
| PUSCH transmission | | | |

PUSCH-ConfigCommon information element is defined in TS38.331 V16.1.0 as below. PUSCH-ConfigCommon information element defines pusch-TimeDomainAllocationList.

PUSCH-ConfigCommon information element

[symbol]

ASN1START [symbol]
TAG-PUSCH-CONFIGCOMMON-START

| | |
|---|---|
| PUSCH-ConfigCommon ::= | SEQUENCE { |
| groupHoppingEnabledTransformPrecoding | ENUMERATED {enabled} |

OPTIONAL, [symbol] Need

[symbol]

| | |
|---|---|
| pusch-TimeDomainAllocationList | PUSCH-TimeDomainResourceAllocationList |

OPTIONAL, [symbol] Need R

| | |
|---|---|
| msg3-DeltaPreamble | INTEGER (−1..6) |

OPTIONAL, [symbol] Need R

| | |
|---|---|
| p0-NominalWithGrant | INTEGER (−202..24) |

OPTIONAL, [symbol] Need [symbol]
...
} [symbol]
TAG-PUSCH-CONFIGCOMMON-STOP [symbol]
ASN1STOP [symbol]
indicates data missing or illegible when filed

UL DMRS configuration is described below.

There are two frequency-domain mapping types for PUSCH DMRS, as shown in FIG. 2. Type 1 and Type 2 have different numbers of CDM groups. Frequency mapping Type 1 is Comb based with 2 CDM groups, and frequency mapping Type 2 is Non-comb based with 3 CDM groups. Msg3 DMRS configuration is defined in TS38.214 V16.3.0. When the transmitted PUSCH is neither scheduled by DCI format 0_1 with CRC scrambled by C-RNTI, CS-RNTI, SP-CSI-RNTI or MCS-C-RNTI, nor corresponding to a configured grant, the UE shall use single symbol front-loaded DMRS of configuration type 1 on DMRS port 0 and the remaining resource elements (REs) not used for DMRS in the symbols are not used for any PUSCH transmission except for PUSCH with allocation duration of 2 or less OFDM symbols with transform precoding disabled, additional DMRS can be transmitted according to the scheduling type and the PUSCH duration as specified in Table 6.4.1.1.3-3 of section 4, TS38.211 V16.0.0 for frequency hopping disabled and as specified in Table 6.4.1.1.3-6 of section 4, TS38.211 V16.0.0 for frequency hopping enabled. If frequency hopping is disabled, the UE shall assume dmrs-AdditionalPosition equals to ‘pos2’ and up to two additional DMRS can be transmitted according to PUSCH duration. If frequency hopping is enabled, the UE shall assume dmrs-AdditionalPosition equals to ‘pos1’ and up to one additional DMRS can be transmitted according to PUSCH duration.

TABLE 64.1.1.3-6
PUSCH DM-RS positions l̅ within a slot for single-
symbol DM-RS and intra-slot frequency hopping enabled.

| | DM-RS positions l̅ | | | | | | | | | | | |
|---|---|---|---|---|---|---|---|---|---|---|---|---|
| | PUSCH mapping type A | | | | | | | | PUSCH mapping type B | | | |
| | l₀ = 2 | | | | l₀ = 3 | | | | l₀ = 0 | | | |
| | dmrs-AdditionalPosition | | | | dmrs-AdditionalPosition | | | | dmrs-AdditionalPosition | | | |
| | pos0 | | pos1 | | pos0 | | pos1 | | pos0 | | pos1 | |
| l_{d} in | 1^{st} | 2^{nd} | 1^{st} | 2^{nd} | 1^{st} | 2^{nd} | 1^{st} | 2^{nd} | 1^{st} | 2^{nd} | 1^{st} | 2^{nd} |
| symbols | hop | hop | hop | hop | hop | hop | hop | hop | hop | hop | hop | hop |
| ≤3 | — | — | — | — | — | — | — | — | 0 | 0 | 0 | 0 |
| 4 | 2 | 0 | 2 | 0 | 3 | 0 | 3 | 0 | 0 | 0 | 0 | 0 |
| 5, 6 | 2 | 0 | 2 | 0, 4 | 3 | 0 | 3 | 0, 4 | 0 | 0 | 0, 4 | 0, 4 |
| 7 | 2 | 0 | 2, 6 | 0, 4 | 3 | 0 | 3 | 0, 4 | 0 | 0 | 0, 4 | 0, 4 |

One of the messages in the RA procedure, Msg3, has turned out to be a potential performance bottleneck in NR networks and it is therefore of interest to improve coverage of this message (channel). Although performance can be improved substantially by performing multiple HARQ retransmissions. However, this generally complicates the procedure, requiring the network to retransmit both Msg2 and grants for TC-RNTI, thereby adding substantial extra PDCCH overhead and latency.

In accordance with some exemplary embodiments, the present disclosure provides a solution for repetition of PUSCH transmission (which is also referred to as “PUSCH repetition” or “Msg3 repetition”) in the random access procedure. The solution provides a variety of techniques for Msg3 repetition, including a mechanism and time-domain resource allocation of Type A Msg3 repetition, different methods to signal the number of repetitions, indicate UE capability of Msg3 repetition, configure Msg3 repetition, and detect Msg3 repetition, and mechanisms for determination of the number of Msg3 repetition by UE. The embodiments of the present disclosure provide methods on detailed design to support Msg3 repetition to improve coverage of PUSCH transmissions before RRC connection is established. The methods reduce both signaling overhead and latency, improves the resource utilization efficiency for Msg3 transmissions, and also make it possible for the terminal device to determine a proper number of Msg3 repetitions or determine whether Msg3 should be repeated.

It is noted that some embodiments of the present disclosure are mainly described in relation to NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does not limit the present disclosure naturally in any way. Rather, any other system configuration or radio technologies may equally be utilized as long as exemplary embodiments described herein are applicable.

PUSCH repetitions Type A for Msg3 has been identified as one of the solutions to improve Msg3 coverage. NR Release 15 has supported PUSCH repetition Type A for UE in RRC_connected mode, which is under further enhancement in NR Rel-17. PUSCH repetition Type A mechanisms can be used for Msg3 initial transmission and/or retransmission with repetition.

In embodiments of the present disclosure, slot availability and procedure of Msg3 repetition, additional signaling of the number of Msg3 repetitions, indication of UE's capability of Msg3 repetition and indication of the number of Msg3 repetitions by DMRS configuration are mentioned.

Some embodiments of Msg3 repetition are described below.

In some embodiments, if Msg3 transmission (which is also referred to as PUSCH transmission herein) is configured to start from slot n and repeat K times, there are two options. Option 1 is using K physical slots, and the Msg3 transmission ends in slot n+K−1. Option 2 is using K available slots, and the Msg3 transmission ends after K repetitions, each repetition with L symbols.

As mentioned in the PCT application No. PCT/CN2020/106760, Msg3 repetition allows a single repetition in each slot, with each repetition occupying the same symbols. In some time division duplex (TDD) UL/DL configurations, there are a small number of contiguous UL slots in a radio frame. To maximize the time diversity gain, multiple Msg3 repetitions do not have to in contiguous slots.

In some embodiments, multiple Msg3 repetitions can be in contiguous or non-contiguous slots, within a radio frame or across frame border. Further, in some embodiments, if UE phase coherency across Msg3 repetitions is required in order for coherent combining or joint channel estimation, UE needs to report gNB its capability of keeping phase coherency across multiple slots.

In NR TDD and FDD network, there are UL slots with 14 UL symbols and DL slots with no UL symbols. In TDD, a third type of slot is a special slot with less than 14 UL symbols, some DL symbols and symbols for DL/UL switch. Below are some examples of unavailable symbols in a slot for Msg3 transmission:
DL symbols, including semi-static DL symbols and semi-static flexible symbols which are later indicated as downlink by DCI format 2_0 with a slot format indicator (SFI) index field; and
GAP symbols between UL symbols and DL symbols.

One or more of below several embodiments can be applied regarding how different types of slots are used and counted for multiple Msg3 repetitions and how unavailable symbols are used.

Denote L as the number of OFDM symbols for Msg3 transmission in a slot, K as the number of Msg3 repetitions. In some embodiments, K may be configured by gNB, which will be described later, or determined by UE based on its capability and network configuration, which will be described later.

In some embodiments, the UE can be RRC/DCI configured one or multiple of the below methods to determine the slots of Msg3 repetitions. Assume Msg3 transmission starts from slot n.

In an embodiment, the Msg3 transmission ends in slot n+K−1. In a slot from slot n to slot n+K−1, if only part of the L scheduled symbols is available for the UE, whether the UL symbols in the slot can be used or not can be configured or predetermined. UE can be RRC/DCI configured or predefined with X1, which is the minimum number of contiguous UL symbols among the L scheduled symbols in a slot which can be used for Msg3 transmission. A slot with less than X1 UL symbols will not be used. If X1=1, all UL symbols (<L) in the slot can be used. If X1=L, the slots with less than L symbols are not used. If X1 is not configured, a default value can be predetermined, for example X1=L.

In some embodiments, if UE is configured to use the less than L UL symbols in a slot from slot n to slot n+K−1, the less than Z UL symbols in the slot can be configured in one or more of below ways. In an embodiment, the UL symbols in the slot are symbol-wise repetition of the same symbols from a previous or subsequent or particular repetition which has all Z scheduled UL symbols available, e.g., the first Msg3 repetition. Namely, it uses the same redundancy version (RV) as that Msg3 repetition. In an embodiment, the UL symbols in the slot are segmentation of the same symbols from a L-symbol repetition in a slot. The transmission in the slot can be counted for RV cycling. In an embodiment, DMRS placement can be configured or predefined. For example, a predefined DMRS placement may be based on the number of contiguous UL symbols in the slot.

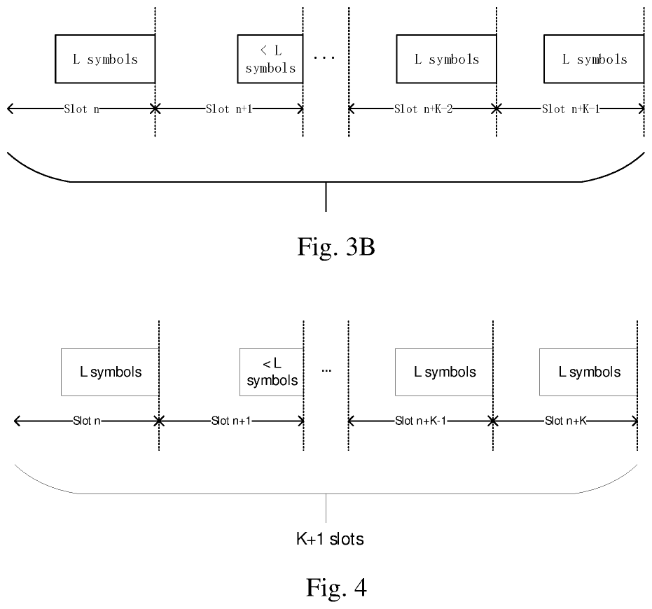

FIGS. 3A and 3B illustrates examples of Msg3 repetition according to some embodiments, respectively. In FIG. 3A, UE uses the same L symbols in each of K slots. FIG. 3B shows that there are less than L UL symbols in slot n+1. With X1=1, the UL symbols in slot n+1 can be used for the TB. UE is configured to transmit the same bits as in the same symbols in the previous slot. With this embodiment, the Msg3 transmission is composed of at most L*K UL symbols.

Alternatively or additionally, in some embodiments, if a slot has only part of the L scheduled symbols available for Msg3 transmission, the slot is not counted as an available slot. Only the slots in which all L scheduled symbols are available are counted, until K slots are found.

In an embodiment, in a slot from the first slot till the last slot, if only some of Z scheduled symbols are available, though the slot is not counted, whether the UL symbols in the slot can be used or not can be configured or predetermined. The less than Z UL symbols in the slot can be configured in the same way as described above.

FIG. 4 illustrates another example of Msg3 repetition according to some embodiments. There are less than L UL symbols in slot n+1 and it is not counted as the available slot. With X1=1, UL symbols in slot n+1 can be used for Msg3 transmission. UE is configured to transmit the same bits as in the same symbols in the previous slot. The last slot is postponed till slot n+K. With this embodiment, the Msg3 transmission is composed of at least L*K UL symbols.

In the embodiments in which K physical slots are counted, the last slot of the Msg3 transmission is fixed. If some slots have less than L UL symbols, the number of Msg3 repetitions with L symbols reduces. The embodiments in which K available slot are counted guarantee the number of Msg3 repetitions with L symbols is K, but enlarges latency and causes uncertainty to the end of the Msg3 transmission.

In some embodiments, one or more of below methods can be used for Msg3 initial transmission and retransmission regarding dynamic SFI. If the dynamic SFI is not configured, UE can be RRC/DCI configured or predetermined whether the semi-static flexible symbols are available for Msg3 transmission. If the dynamic SFI is configured, UE can use the dynamic UL symbols for Msg3 transmission.

As described in the PCT application No. PCT/CN2020/106760, frequency hopping can be enabled for Msg3 repetitions, including intra-slot frequency hopping and inter-slot frequency hopping. In some embodiments, it can be configured or predefined on whether the frequency hopping applies for Msg3 transmission in a slot with less than a threshold number of the L scheduled symbols for each PUSCH repetition. For example, the Msg3 transmission in a slot with at least a minimum number of OFDM symbols is allowed for the frequency hopping. It is to avoid a hop with too short length.

In RANI #104bis-e meeting, a working assumption is reached to use available slots to count the repetitions with a number indicated by a repetition factor from network. That is, the number of repetitions is counted on the basis of available slots for Type A PUSCH repetitions for Msg3.

Some embodiments for determination of available slots are described below.

The available slots of Msg3 repetition can be determined based on one or more of the following methods:
cell specific TDD uplink downlink configuration: for example, tdd-UL-DL-ConfigurationCommon is used to determine which slot is available for Msg3 repetition.
configuration in RAR: for example, whether and which TDD uplink downlink signaling (dedicated signaling or common signaling) is to be used for determination of available slots can be based on explicit signaling in RAR.
configuration in DCI for repetition of Msg3 retransmission: for example, whether and which TDD uplink downlink signaling (dedicated signaling or common signaling) is to be used for determination of available slots can be based on explicit signaling in DCI scheduling a Msg3 retransmission.

In some embodiments, which configuration is used for the determination of available slots depends on whether it is a contention based random access (CBRA) or a contention free random access (CFRA). For example, in CBRA, the determination of available slots can only be based on a cell specific TDD uplink downlink configuration. For Msg3 PUSCH scheduled by RAR in CFRA, a dedicated TDD uplink and downlink configuration can be used for the determination of available slot for Msg3 repetition transmission. In addition, in CFRA, the cell specific TDD uplink downlink configuration can be used as well.

In some embodiments, the determination of available slots may be further based on collision with other uplink transmission from the same UE and/or a cancellation indication (CI).

In some embodiments, the determination of available slots for transmission of Msg3 repetition can be done prior to transmission of the first Msg3 repetition and/or during the transmission of Msg3 repetitions.

In some embodiments, the available slot may be a slot not configured as a downlink slot. In some embodiments, the available slot may be a slot not configured with a set of downlink symbols overlapping with the TDRA (time domain resource allocation) of the Msg3 repetition. That is, the available slot may be a slot in which a set of symbols allocated for the Msg3 repetition is not configured as downlink. In some embodiments, the available slot may be a slot configured as an uplink slot or a slot with a set of symbols allocated for Msg3 repetition being configured as uplink.

In some embodiments, a slot for Msg3 repetition is determined as unavailable if at least one of the symbols indicated by TDRA allocated for Msg3 repetition in the slot overlaps with a symbol not intended for UL transmission.

Another issue is that collision may happen between Msg3 transmission and other UL transmissions, which needs to be addressed as well. Some embodiments of collision handling are described below.

In some embodiments, collision handling between multiple time-overlapping UL transmissions, including Msg3 repetitions which are based on the available slots, can be based on priority. UE may determine which physical channel/signal is prioritized based on a higher layer configuration, DCI and/or predetermined rules, and may transmit it in the overlapping symbols in the slot.

In some embodiments, the priority may be based on a time order of scheduling signaling. For example, UL physical channel/signal which is scheduled earlier either by DCI or high layer has high priority. As Msg3 is scheduled by RAR or DCI, UE determines its timing as the last symbol of PDSCH of RAR or PDCCH carrying the DCI. In some embodiments, the priority may be a pre-determined/configured priority according to a content of UL transmission. For example, Msg3 repetition has the highest priority. In some embodiments, the priority may be based on a type of scheduling signaling. For example, L1 scheduled transmission has a higher priority than a high layer scheduled transmission.

In some embodiments, the collision handling may be done by the UE prior to transmission of the first Msg3 repetition and/or during transmission of Msg3 repetitions. In some embodiments, the collision handling may apply to both initial transmission and retransmission of Msg3 repetition.

Another issue is about determination of redundancy version (RV) which may depend on the determination of available slots. The redundancy version for Msg3 repetition may be determined based on one or more of the following methods:
The RVs are cycled across the determined available slots: in this case, the slot with a cancelled repetition due to the collision handling is still counted for the RV determination;
The RVs are cycled across the transmitted Msg3 repetition: in this case, the slot with the repetition cancelled due to the collision handling is not counted for the RV determination.

Some embodiments of configuration of Msg3 repetition are described below.

In the case that the gNB knows UE's capability of Msg3 repetition, for example by different preamble/PRACH occasion grouping, RAR content can be known by both the gNB and the UE, e.g., a new field can be added in RAR. But if the gNB is unaware of UE's capability of Msg3 repetition, RAR content needs to be the same as in Release 15/16 to keep backward compatibility. In this case, UE can determine the number of Msg3 repetitions on its own.

In Release 15 and Release 16, K2 of PUSCH-TimeDomainResourceAllocation information element indicates the slot for Msg3 transmission. In the embodiments of the present disclosure, K2 indicates the first slot for Msg3 repetitions. The gNB can choose a slot with the L scheduled symbols available as the first slot for Msg3 transmission.

In some embodiments, one or more candidate numbers of Msg3 repetitions may be semi-statically configured in SIB1. For example, numberOfRepetitions is configured in PUSCH-ConfigCommon information element in SIB1 as below.

PUSCH-ConfigCommon information element

[symbol]

ASN1START [symbol]
TAG-PUSCH-CONFIGCOMMON-START

| | |
|---|---|
| PUSCH-ConfigCommon ::= | SEQUENCE { |
| groupHoppingEnabledTransformPrecoding | ENUMERATED {enabled} |

OPTIONAL, [symbol] Need R

| | |
|---|---|
| pusch-TimeDomainAllocationList | PUSCH-TimeDomainResourceAllocationList |

OPTIONAL, [symbol] Need R

| | |
|---|---|
| msg3-DeltaPreamble | INTEGER (−1..6) |

OPTIONAL, [symbol] Need R

| | |
|---|---|
| p0-NominalWithGrant | INTEGER (−202..24) |

OPTIONAL, [symbol] Need R

| | |
|---|---|
| numberOfRepetitions | ENUMERATED {n1, n2, n3, n4, n7, n8, n12, n16} |

OPTIONAL,
...
} [symbol]
TAG-PUSCH-CONFIGCOMMON-STOP [symbol]
ASN1STOP [symbol]
indicates data missing or illegible when filed

In some embodiments, if the gNB does not configure a UE-specific number of Msg3 repetitions, UE may choose one of the configured candidate numbers in SIB1 for Msg3 repetitions.

Alternatively or additionally, in some embodiments, regardless of a list of candidate numbers in numberOfRepetitions in SIB1, the gNB can set a default and/or maximum and/or predetermined numbers of Msg3 repetitions. The benefit is to limit resources of Msg3 transmission to a reasonable level and ease gNB blind detection.

In some embodiments, the default and/or maximum number of Msg3 repetitions may be configured in SIB1/RAR/Msg2 PDCCH or may be predetermined. In the case that the gNB does not configure a specific number of Msg3 repetitions in RAR/Msg2 PDCCH, UE may transmit the Msg3 repetitions according to the configuration of Msg3 repetition.

For example, table 1 shows several configurations of Msg3 repetition. Yes or no indicates presence or absence of the field in SIB1/RAR/Msg2 PDCCH. If the gNB does not configure the number of Msg3 repetition, UE may transmit the Msg3 repetitions by a default value, as configuration index 1 shows. For configuration index 2, UE may determine a number not more than the maximum value for Msg3 repetitions. If neither default nor maximum value is configured, UE may use a predetermined number. The number can be fixed to 1, for example.

TABLE 1

| Configuration | default | maximum | Number of Msg3 |
|---|---|---|---|
| index | value | value | repetitions |
| 1 | yes | yes/no | Default value |
| 2 | no | yes | 1~maximum value |
| 3 | no | no | Predetermined value |

Alternatively or additionally, in some embodiments, the number of Msg3 repetitions can be dynamically configured in RAR or Msg2 PDCCH either with a separate field, the unused field in RAR or unused state of DCI and/or be jointly encoded in the time domain resource allocation (TDRA). For example, numberOfRepetitions is jointly encoded in TDRA table as below.

PUSCH-TimeDomainResourceAllocation information element

[symbol]

ASN1START

[symbol]

PUSCH-TimeDomainResourceAllocationList ::= SEQUENCE (SIZE (1..maxNrofUL-Allocations)) OF
PUSCH-TimeDomainResourceAllocation
PUSCH-TimeDomainResourceAllocation ::= SEQUENCE {

| | |
|---|---|
| k2 | INTEGER(0..32) |

OPTIONAL, [symbol] Need S

| | |
|---|---|
| mappingType | ENUMERATED {typeA, typeB}, |
| startSymbolAndLength | INTEGER (0..127) |
| numberOfRepetitions | ENUMERATED {n1, n2, n3, n4, n7, n8, n12, n16} |

OPTIONAL,
} [symbol]
indicates data missing or illegible when filed

In some embodiments, if the number of Msg3 repetitions is jointly encoded in TDRA table, one TDRA entry can be indicated in RAR for Msg3 initial transmission and in DCI 0_0 scrambled with TC-RNTI for Msg3 retransmission. Alternatively, in some embodiments, if UE is configured with TDRA table but the number of Msg3 repetitions is not indicated in RAR or DCI0_0 for Msg3 initial transmission or Msg3 retransmission, UE may choose one from the configured values in TDRA table.

Some embodiments of procedure of Msg3 repetition are described below.

In some embodiments, the configuration of Msg3 repetition may be provided by the network node blindly or based on the UE's capability of Msg3 repetition indicated before scheduling Msg3. The actual number of repetitions or whether Msg3 is repeated may be determined by UE and/or by scheduling information from the network node.

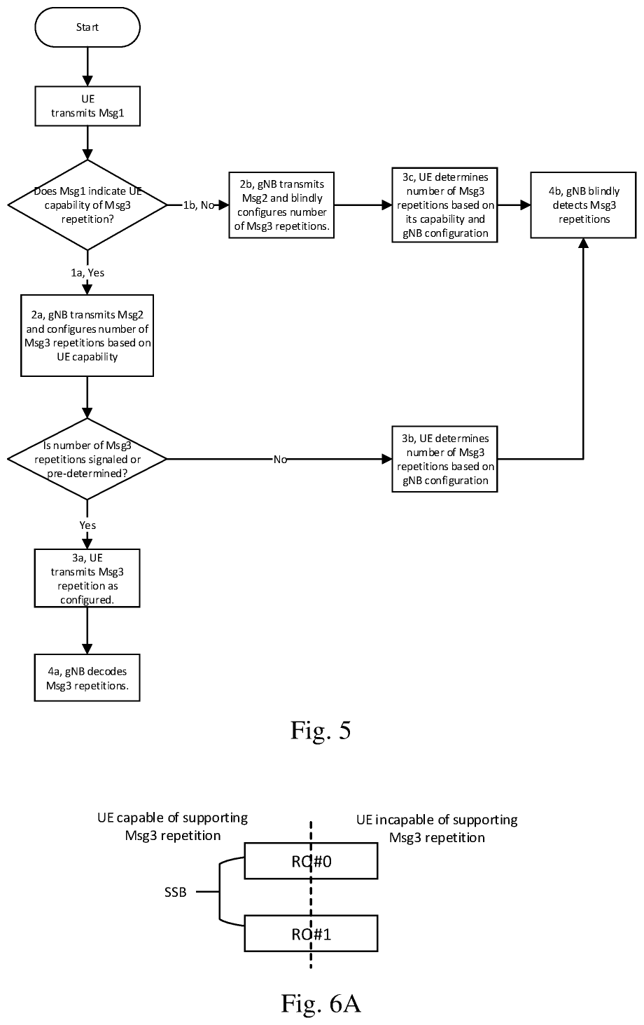

FIG. 5 illustrates an example of Msg3 initial transmission in the four-step random access procedure. One or more of the following procedures can be adopted regarding indication of UE capability of Msg3repetition.

As shown in FIG. 5, in step 1, UE transmits Msg1. At step 1a, the UE's capability of Msg3 repetition is indicated by Msg1. The UE can even signal a recommended number of Msg3 repetitions in Msg1. Then the process goes to step 2a. At step 1b, the UE's capability of Msg3 repetition is not indicated by Msg1. Then the process goes to step 2b. At step 2b, the gNB sends Msg2 and configures the number of Msg3 repetitions. The gNB can determine whether to configure the number of Msg3 repetitions assuming that the UE supports Msg3 repetition. At step 2a, the gNB can configure the number of Msg3 repetitions according to UE's capability of Msg3 repetition. If UE does not support Msg3 repetition, the repetition factor indication field is reserved. Then the process goes to step 3a or 3b. In step 3, the UE transmits Msg3. At step 3a, if a specific number of Msg3 repetitions is signaled or predetermined after step 2a, the UE transmits Msg3 accordingly, and the process goes to step 4a. At step 3b, if a specific number of Msg3 repetitions cannot be determined after step 2a, for example when the gNB configures a range of numbers of Msg3 repetitions between 1 and a maximum number, the UE determines the number of repetitions by itself and transmits Msg3 accordingly. Then the process goes to step 4b. At step 3c, if the UE supports Msg3 repetition, it transmits according to gNB's blind configuration. If the UE does not support Msg3 repetition, it transmits Msg3 without repetition. Then the process goes to step 4b. In step 4, the gNB decodes Msg3. At step 4a, the gNB decodes the specific number of Msg3 repetitions. At step 4b, the gNB blindly detects Msg3 repetitions if Msg3 repetition is configured and/or scheduled.

In some embodiments, if UE needs to determine the number of Msg3repetition by itself, the actual number of repetitions used by UE is no larger than the maximum number of repetitions signaled from network. For example, when a repetition factor of 16 for Msg3 transmission is signaled from the network node to UE via RAR or DCI for Msg3 initial transmission or Msg3 retransmission, the actual number of repetitions cannot be larger than 16.

Some embodiments of indication of UE's capability of Msg3 repetition are described below.

In some embodiments, UE can indicate its capability of Msg3 repetition to the gNB through Msg1 transmission. This can be done by partitioning PRACH preambles or PRACH occasions among UE capable of supporting Msg3 repetition and UE incapable of supporting Msg3 repetition.

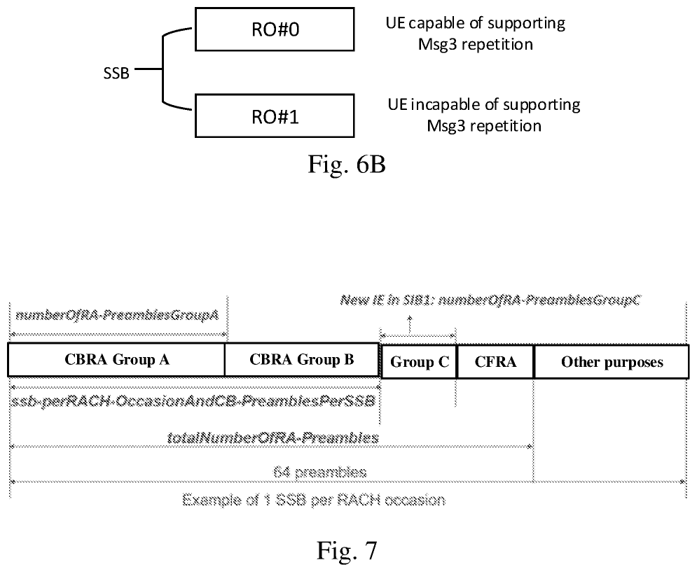

In some embodiments, which PRACH preambles may be used by UE capable of supporting Msg3 repetition or UE incapable of supportingMsg3 repetition can be determined based on the preamble group in one PRACH occasion. The configuration of the preambles used for UE capable of supporting Msg3 repetition or UE incapable of supporting Msg3 repetition may be transmitted by dedicated or broadcast RRC signaling. FIG. 6A illustrates an example of the RA preamble partitioning. As shown in FIG. 6A, if one SSB is associated with two PRACH occasion, UE capable of supporting Msg3 repetition may use either half preambles of both PRACH occasion or all preambles of one specific RO.

In some embodiments, which PRACH preambles can be used by UE capable of supporting Msg3 repetition or UE incapable of supportingMsg3 repetition may be determined based on different PRACH occasions. FIG. 6B illustrates an example of the PRACH occasion partitioning. As shown in FIG. 6B, preambles of RO #0 are configured to be used for UE capable of supporting Msg3 repetitions, and preambles of RO #1 are configured to be used for UE incapable of supporting Msg3 repetition.

In an embodiment, the capability of Msg3 repetition of the UE may be indicated by a PRACH preamble group. The preamble group may be a set of preambles defined in Release 15 for group A or group B. Alternatively, a new preamble group C may be defined. The new preamble group C may be a part of preambles that are additionally configured and which can be a subset of preambles used for contention-free random access (CFRA). With this embodiment, the network node can easily determine whether the UE supports Msg3 repetition based on the ID of the preamble transmitted by the UE.

In some embodiments, the UE that is capable of supporting Msg3 repetition can identify group C preambles configured in SIB1. This preamble group C configuration is not used by legacy UEs or those of new release that do not support Msg3 repetition. The group C preambles can be configured in several ways. For example, numberofRA-PreamblesGroupC can be created as additional contention based random access (CBRA) preambles and can use a portion of CFRA preambles. FIG. 7 illustrates an example of 1 SSB per PRACH occasion. In FIG. 7, the group C preambles can use the beginning preambles of those allocated to CFRA. A new information element (IE), numberofRA-PreamblesGroupC, may be configured in SIB1. Alternatively, the group C preambles can use the middle or the ending preambles of CFRA.

Alternatively or additionally, in some embodiments, the numberofRA-PreamblesGroupC can use some quota from other purposes. Further, in some embodiments, the numberofRA-PreamblesGroupC may be located between CBRA Group A or CBRA Group B.

For the four-step random access procedure, firstly, the gNB may configure the SIB1 with the preamble group C for a UE that can support Msg3 repetition. Then, the UE that supports Msg3 repetition may send a preamble of group C to the gNB to indicate the UE's capability of Msg3 repetition.

Alternatively or additionally, in some embodiments, the preamble group C may be divided into group C1 and group C2. In some embodiments, it is determined whether group C1 or group C2 is used based on a predetermined condition.

In some embodiments, the condition may be whether Msg3 size is below a threshold. If the Msg3 size is below a threshold, Group C1 is used. Otherwise, group C2 is used.

In some embodiments, the condition may be whether a recommended number of Msg3 repetitions by UE is equal to or below a threshold. Group C1 may be used if the recommended number of Msg3 repetitions is equal to or below a threshold. Otherwise, group C2 is used. For example, the threshold may equal 1. In this case, receiving a preamble from Group C1 indicates that UE does not need Msg3 repetition, while receiving one preamble from group C2 indicates that UE needs such coverage enhancement scheme. Then, the gNB may send a UL grant for Msg3 in Msg2 RAR, considering the recommended number of repetitions. Finally, the UE transmits Msg3 according to the UL grant.

Alternatively or additionally, in some embodiments, when Msg3 repetition is activated in SIB1and group C is not configured in SIB1, UE may use group B to implicitly indicate UE's support of Msg3 repetition.

Alternatively or additionally, in some embodiments, the UE's capability of Msg3 repetition may be indicated by a subset of PRACH occasions where a preamble associated with the capability is transmitted. The subset of PRACH occasions may be determined per SSB. For example. a UE capable of supporting Msg3 repetition may be provided a number N of SSBs associated with one PRACH occasion, and one SSB is mapped to 1/N valid PRACH occasions. A subset of PRACH occasions may be reserved for UEs capable of supporting Msg3 repetition. With the embodiments, the network node can easily determine whether multiple Msg3 repetitions may be received based on the PRACH occasion in which the preamble is received, and no additional PRACH occasion needs to be configured.

Alternatively or additionally, in some embodiments, the UE capability of Msg3 repetition may be indicated by separately configured PRACH occasions for Msg3 repetition in frequency domain and/or time domain. With this embodiment, the network node can easily determine the UE's capability of Msg3 repetition based on whether the PRACH occasion with the preamble received is a separately configured PRACH occasion or a legacy PRACH occasion. Such embodiments introduce additional PRACH occasions for UEs capable of supporting Msg3 repetition and keep the capacity of PRACH occasions for UEs incapable of supporting Msg3 repetition.

In some embodiments, in the frequency domain, SIB1 may indicate which additional PRACH occasions on top of the PRACH occasions configured for UEs incapable of supporting Msg3 repetition. In some embodiments, in the time domain, a separate PRACH configuration index can be introduced, e.g. in SIB1, to configure separate set of PRAH occasions for UE capable of supporting Msg3 repetition.

Alternatively or additionally, in some embodiments, the UE capability of Msg3 repetition may be indicated by a random access type. The random access type may be a two-step RA type, a four-step RA type, CBRA type or CFRA type. As an example, assuming that the UE which is capable of and recommends Msg3 repetition selects the four-step RA type, while the UE is not expected to be scheduled with Msg3 repetition when the two-step RA type is selected. The network node may configure that a UE capable of supporting Msg3 repetition only uses one type of random access procedure. Thus, whenever UE performs the random access based upon that type of procedure, it may to a certain degree understand that this UE supports Msg3 repetition.

Alternatively or additionally, in some embodiments, one or more of the following metrics may be used to implicitly indicate the UE capable of supporting Msg3 repetition:
a) whether a reference signal received power (RSRP) is below a certain threshold: True/False;
b) UE in a poor coverage or cell border area; and
c) the camped SSB index is not the best SSB index.

As an example, the numberofRA-PreamblesGroupC can be partitioned in different preamble groups such as preamble group C1 and preamble group C2. If the result of one or more of the metrics is true, the UE selects preamble group C2, else UE selects preamble group C1. Additionally, preamble group C may have a further preamble group C3. When the UE does not know or could not perform the measurements but supports Msg3 repetition, the UE selects preamble group C3.

Some embodiments of implicit indication of Msg3 repetition are described below.

As described above, the number of repetitions can be indicated by the network node in RAR/DCI. Whether the UE applies repetition may depend on UE's capability which may require the network node doing blind detection. To minimize the blind detection complexity, whether repetition is actually applied may be indicated by DMRS used for Msg3 transmission.

In NR Release 15/16, only DMRS port 0 of CDM group 0 with DMRS type 1 can be used for Msg3 transmission and the number of DMRS symbols are one fronted DMRS symbol plus two additional DMRS symbols. To support the implicit indication of Msg3 repetition, multiple DMRS resources need to be selected by UE.

In some embodiments, whether Msg3 repetition is applied by the UE may be indicated by the selected DMRS resources. The selected DMRA resources may be one or more of the followings: DMRS port, CDM group, DMRS configuration type, usage of additional DMRS symbol, and DMRS sequence.

In the case of DMRS port, for example, when UE does msg3 repetition, the UE will use DMRS port 1 of CDM group 0 with DMRS type 1. In the case of CDM group, for example, when UE does msg3 repetition, the UE will use DMRS port of CDM group 1 of DMRS type 1. In the case of DMRS configuration type, for example, when UE does msg3 repetition, the UE will use DMRS with DMRS type 2, otherwise DMRS with DMRS type 1 is used. In the case of additional DMRS symbol, when UE does msg3 repetition, the UE will use only fronted DMRS symbol, otherwise UE will use one fronted DMRS symbol plus two additional DMRS symbols. In the case of DMRS sequence, for example, for cyclic prefix (CP) OFDM, a new scrambling ID may be either signaled (in RRC, MAC CE or RAR or LI signaling) or predetermined and used by UE when the UE is able to do msg3 repetition.

Further, in some embodiments, the detailed number of repetitions may also be determined by UE on top of the number of repetitions signaled from the network node, which can also be based on the DMRS resources.

In the random access procedure shown in FIG. 5, when the gNB blind detects the number of Msg3 repetitions which is determined by UE, the number can be implicitly indicated by a Msg3 DMRS port index. An example of mapping between DMRS port index and number of Msg3 repetitions is that if UE is configured with multiple candidate numbers of Msg3 repetitions to choose from, different numbers of Msg3 repetitions can be indicated by different DMRS antenna port (AP) starting from #0. For example, if numberOfRepetitions is configured with {n1, n2, n3, n4, n7, n8, n12, n16}, Msg 3 DMRS AP #0 indicates n1, AP #1 indicates n2, . . . , AP #7 indicates n16. In NR Release 15/16, Msg3 uses single symbol front-loaded DM-RS of configuration type 1 on DM-RS port 0. Apart from DMRS port, other DMRS configuration can also implicitly indicate the number of Msg3 repetitions.

In some embodiments, the number of Msg3 repetitions may be implicitly indicated by one or more of the followings: DMRS configuration type, CDM group, and DMRS sequence.

For the DMRS configuration type, if UE transmits Msg3 with repetitions larger than a threshold, the UE may use one antenna port of DMRS configuration type 2. Otherwise, the UE uses DMRS configuration type 1.

For the CDM group, If UE uses DMRS configuration type 1, CDM group 0/1 can be used to indicate Msg3 transmission with repetitions less than a threshold or not. If DMRS configuration type 2 is used, CDM group 0 can be used to indicate Msg3 without repetition and group 1 and 2 can be used to indicate different groups of Msg3 repetition numbers. For example, if numberOfRepetitions configured with {n1, n2, n3, n4, n7, n8, n12, n16} and DMRS configuration type 2 are used, CDM group 0 can indicate there is no msg3 repetitions, i.e., n1, CDM group 1 can indicate the next four candidate numbers, n2, n3, n4, n7, and CDM group 2 can indicate the remaining numbers, n8, n12, n16.

If two DMRS configuration types and their CDM groups are used together, their combinations can indicate five different groups of numbers of Msg3 repetitions. For example, DMRS configuration type 1 and CDM group 0 can indicate Msg3 transmission without repetition.

As DMRS configuration type 1 and 2 use different resource element (RE) resources and DMRS antenna ports of different CDM groups also use different RE resources, it is easier for gNB to detect energy in different RE groups than the antenna port index. Indication by DMRS configuration type and/or CDM group can also be used together with DMRS AP to assist gNB to detect the number of Msg3 repetitions.

For DMRS sequence, different DMRS sequences can be used to indicate the number of repetitions. For example, Discrete Fourier Transform (DFT)-Spread OFDM waveform which has lower peak to average power ratio (PAPR) than CP-OFDM is beneficial for coverage enhancement. In this case, Msg3 DMRS is generated according to

$$r ( n ) = {r}_{u , v}^{( α , δ )} ( n ) , n = 0 , 1 , … , {M}_{s c}^{P U S C H} / {2}^{δ} - 1$$

In Release 15/16, for Msg3 transmission, cyclic shift α=0. Here α can implicitly indicate different numbers of Msg3 repetitions. Same as in Release 15/16, α=0 is used to indicate Msg3 transmission without repetition. If UE is configured with 1 candidate number of Msg3 repetitions, α=0 and pi respectively indicate Msg3 transmission without and with repetition. If UE is configured with 2˜3 non-one candidate numbers of Msg3 repetitions, the numbers of repetitions are respectively represented byαa=pi/2, pi and pi*3/2. If UE is configured with 4˜7 non-one candidate numbers, the numbers of repetitions are respectively represented by α=pi/4, pi/2, pi*3/4, pi, pi*5/4, pi*3/2 and pi*7/4.

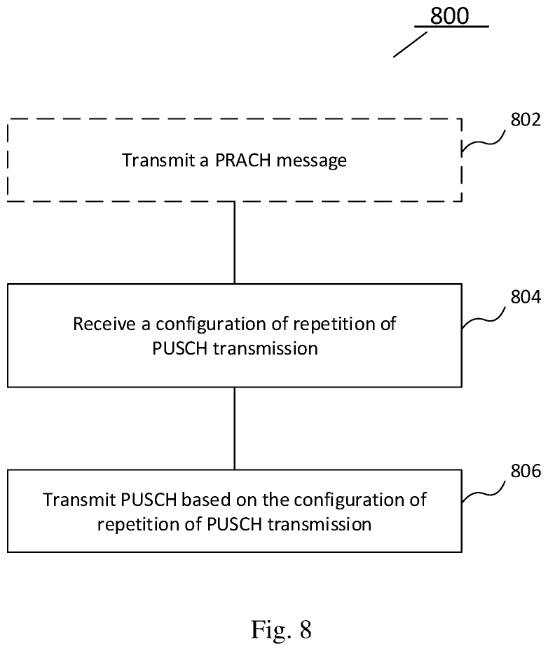

FIG. 8 is a flowchart illustrating a method 800 according to some embodiments of the present disclosure. The method 800 illustrated in FIG. 8 may be performed by an apparatus implemented in/as a terminal device or communicatively coupled to a terminal device. In accordance with an exemplary embodiment, the terminal device may be a UE.

According to the exemplary method 800 illustrated in FIG. 8, the terminal device receives a configuration of repetition of PUSCH transmission for a message in a random access procedure from a network node, as shown in block 804. The network node may be a base station, e.g., gNB. In some embodiments, the message in the random access procedure may be a message 3 (Msg3) in the four-step random access procedure.

In some embodiments, the configuration of repetition of PUSCH transmission may be received in RAR, system information or DCI. The DCI may be included in Msg2 PDCCH or PDCCH indicating Msg3 retransmission.

In some embodiments, the configuration of repetition of PUSCH transmission may be indicated in a separate field or an unused field (e.g., CSI request) in RAR. In this case, the configuration of repetition of PUSCH transmission comprises a configured number of repetitions by the network node. In some embodiments, the configured number of repetitions may be a UE specific number of repetitions or a maximum number of repetitions.

In some embodiments, the configuration of repetition of PUSCH transmission may be indicated in a separate field in SIB1. In an embodiment, the configuration of repetition of PUSCH transmission is indicated in PUSCH-ConfigCommon information element in SIB1. In another embodiment, the configuration of repetition of PUSCH transmission is jointly encoded in a time domain resource allocation (TDRA) table in SIB1. In this case, the configuration of repetition of PUSCH transmission may comprise at least one of the followings: one or more candidate numbers of repetitions, a default number of repetitions, and a maximum number of repetitions.

In some embodiments, the configuration of repetition of PUSCH transmission may be indicated in an unused state of DCI. In this case, the configuration of repetition of PUSCH transmission may comprise a UE specific number of repetitions or a maximum number of repetitions.

In some embodiments, the configuration of repetition of PUSCH transmission may comprise information related to determination of available slots for the repetition of PUSCH transmission. The information related to determination of available slots for the repetition of PUSCH transmission may indicates which slot is an available slot for the Msg3 repetition. Alternatively or additionally, the information related to determination of available slots may indicate whether and which Time Division Duplexing, TDD, uplink downlink signaling is to be used for the determination of available slots.

In some embodiments, the information related to determination of available slots for the repetition of PUSCH transmission may be included in a cell specific TDD uplink downlink configuration. In some embodiments, the information related to determination of available slots may be included in RAR for initial transmission of Msg3 repetition. In some embodiments, the information related to determination of available slots may be included in DCI for retransmission of Msg3 repetition.

In some embodiments, the available slot may a slot not configured as a downlink slot. In some embodiments, the available slot may be a slot in which a set of symbols allocated for the repetition of PUSCH transmission is not configured as downlink. In some embodiments, the available slot may be a slot configured as an uplink slot, and/or a slot in which a set of symbols allocated for the repetition of PUSCH transmission is configured as uplink.

In some embodiments, the configuration of repetition of PUSCH transmission may further comprise priority information for collision handling between the repetition of PUSCH transmission and other uplink transmission from the same terminal device.

In some embodiments, the priority information may be included in a higher layer configuration and/or DCI. In some embodiments, the priority information may be predetermined or predefined.

In some embodiments, the priority information may be based on a time order of scheduling signaling, or a content of uplink transmission, or a type of scheduling signaling.

In some embodiments, the collision handling may be based on the priority information received prior to transmission of the first repetition of PUSCH transmission. Further, the collision handling may be further based on the priority information received during transmission of the repetitions of PUSCH transmission.

Then in block 806, the terminal device transmits a PUSCH to the network node based on the configuration of repetition of PUSCH transmission received in block 804. In some embodiments, the terminal device may determine a number of repetitions to be used for the PUSCH transmission based on the configuration of repetition of PUSCH transmission, and then transmit the PUSCH based on the determined number of repetitions.

In some embodiments, when the configuration of repetition of PUSCH transmission is received in the RAR or DCI, the terminal device may determine the number of repetitions based on the configured number of repetitions in the RAR or DCI. In an embodiment, the terminal device may determine the number of repetitions to be the UE specific number of repetitions if the configured number of repetitions is the UE specific number of repetitions. Alternatively or additionally, the terminal device may determine the number of repetitions to be a number not more than the maximum number of repetitions, if the configured number of repetitions is the maximum number of repetitions.

In some embodiments, when the configuration of repetition of PUSCH transmission is received in the system information and not received in the RAR or DCI, the terminal device may determine the number of repetitions based on the configuration in the system information. In an embodiment, when the configuration of repetitions of PUSCH transmission comprises only one or more candidate number of repetitions, the terminal device may choose one candidate number of repetitions from the one or more candidate numbers of repetitions as the number of repetitions. In another embodiment, when the configuration of repetitions of PUSCH transmission comprises the default number of repetitions or both the default number of repetitions and the maximum number of repetitions, the terminal device may determine the number of repetitions to be the default number of repetitions. In still another embodiment, when the configuration of repetitions of PUSCH transmission comprises the maximum number of repetitions, the terminal device may determine the number of repetitions to be a number not more than the maximum number of repetitions.

In some embodiments, when the configuration of repetition of PUSCH transmission is jointly encoded in the TDRA table in SIB1, a TDRA entry of the TDRA table may be received in the RAR for Msg3 initial transmission or DCI for Msg3 retransmission. In this case, the terminal device may determine the number of repetitions based on the TDRA entry.

Upon the determination of the number of repetitions by the terminal device, the terminal device may transmit the PUSCH based on the determined number of repetitions.

In some embodiments, the terminal device may determine one or more slots among K slots from a first slot for the repetitions to be used for repetitions of PUSCH transmission, wherein K represents the determined number of repetitions. Then for each slot of the K slots in which all L scheduled UL symbols for PUSCH transmission are available, the terminal device may transmit a repetition by configuring the L scheduled UL symbols and placing DMRS in the slot. For each slot of the K slots in which part of the L scheduled UL symbols is available, the terminal device may determine whether a number of the available UL symbols is not less than a first threshold. The first threshold may be transmitted via radio resource control, RRC, signaling or downlink control information, DCI, or the first threshold is predefined. When the number of the available UL symbols is not less than the first threshold, the terminal device may perform a symbol-wise repetition from a particular repetition which has the L scheduled UL symbols available on the available UL symbols and placing DMRS in the slot. Thus, the UL symbols in the slot are symbol-wise repetition of the same symbols from the particular repletion. When the number of the available UL symbols is less than the first threshold, the terminal device does not use the slot to transmit the PUSCH.

In some embodiments, for a slot from a first slot for repetitions of PUSCH transmission, when the slot has all the Z scheduled UL symbols for PUSCH transmission available, i.e., the slot is considered as an available slot, the terminal device may transmit a repetition by configuring the L scheduled UL symbols and placing DMRS in the slot, and increment a slot counter for the available slot. When the slot has part of the L scheduled UL symbols available, the terminal device may determine whether a number of the available UL symbols is not less than the first threshold. When the number of the available UL symbols is not less than the first threshold, the terminal device may perform a symbol-wise repetition from a particular repetition which has the L scheduled UL symbols available on the available UL symbols and placing DMRS in the slot. Thus, the UL symbols in the slot are symbol-wise repetition of the same symbols from the particular repletion. When the number of the available UL symbols is less than the first threshold, the terminal device does not use the slot to transmit the PUSCH. The terminal device repeats the above operation for a next slot, until the slot counter reaches the determined number of repetitions.

In some embodiments, the placement of the DMRS in the slot may be configured or predefined. Alternatively or additionally, in some other embodiments, the particular repetition may be determined further based on RV cycling.

Additionally, in some embodiments, in addition to determining the number of repetitions, the terminal device may further determine respective available slots for the determined number of repetitions, based on the information related to determination of available slots included in the configuration of repetition of PUSCH transmission. Then the terminal device may transmit the PUSCH in the respective available slots.

In some embodiments, the random access procedure may be contention based random access, CBRA. In this case, the available slots may be determined based on the cell specific TDD uplink downlink configuration. In some embodiments, the random access procedure may be contention free random access, CFRA. In this case, the available slots may be determined based on a dedicated TDD uplink downlink configuration and/or the cell specific TDD uplink downlink configuration.

In some embodiment, the available slots may be determined further based on collision with other uplink transmission from the same terminal device and/or a cancellation indication.

In some embodiments, if at least one of a set of symbols allocated for the repetition of PUSCH transmission in an available slot overlaps with a symbol not intended for an uplink transmission, the available slot is determined as unavailable.

In some embodiments, the available slots may be determined prior to transmission of the first repetition of PUSCH transmission and/or during transmission of the repetitions of PUSCH transmission.

In some embodiments, redundancy versions (RVs) for the repetitions of PUSCH transmission are cycled across the determined available slots. Alternatively, redundancy versions for the repetitions of PUSCH transmission are cycled across the transmitted repetitions of PUSCH transmission.

In some other embodiments, the slots for the repetitions of PUSCH transmission are contiguous or non-contiguous within one radio frame or across frame border. In this case, the terminal device may transmit a capability report indicating a capability of keeping phase coherency across multiple slots to the network node.

Additionally, in some embodiments, the terminal may check, for each of the slots for the repetitions of PUSCH transmission, whether a dynamic SFI is configured for the slot. If the dynamic SFI is not configured, the terminal device determines whether semi-static flexible symbols are available for PUSCH transmission. If the dynamic SFI is configured, the terminal device may determine whether semi-static flexible symbols are changed as DL symbols, and determine the semi-static flexible symbols changed as the DL symbols are unavailable for PUSCH transmission.

Additionally, in some embodiments, the terminal device may apply frequency hopping to the repetition in the slot in which part of the Z scheduled UL symbols is available, when the number of the available UL symbols of the L scheduled UL symbols in the slot is not less than a second threshold. Otherwise, the terminal device does not apply the frequency hopping.

In some embodiments, a DMRS configuration for the DMRS in the slot may be determined based on at least one of application of repetition to PUSCH transmission and the number of repetitions to be used for the PUSCH transmission. A mapping between application of repetition and DMRS configurations and A mapping between numbers of repetitions and DMRS configurations may be configured or predefined. In an embodiment, the application of repetition may be mapped to at least one of the followings in the DMRS configuration: a DMRS port, a CDM group, a DMRS configuration type, usage of an additional DMRS symbol, and a DMRS sequence. In another embodiment, the number of repetitions is mapped to at least one of the followings in the DMRS configuration: a DMRS port, a DMRS configuration type, a CDM group, and a DMRS sequence.

Additionally, the terminal device may transmit a PRACH message to the network node, as shown in block 802. In some embodiments, the PRACH message may indicate a capability of PUSCH repetition of the terminal device. In some embodiments, the capability of PUSCH repetition is indicated by a random access, RA, preamble or a PRACH occasion used in the PRACH message.

Prior to initiating the random access procedure, the terminal device may receive system information indicating a plurality of RA preamble groups and one or more of the plurality of RA preamble groups to be used for a terminal device capable of supporting PUSCH repetition.

In an embodiment, the plurality of RA preamble groups comprises RA preamble group A and RA preamble group B, and the RA preamble group B is configured to be used for a terminal device capable of supporting PUSCH repetition.

In an embodiment, the plurality of RA preamble groups comprises RA preamble group A, RA preamble group B and RA preamble group C, and the RA preamble group C is configured to be used for a terminal device capable of supporting PUSCH repetition. The RA preamble group C comprises a subset of contention-free random access preambles and is configured as contention based random access preambles. Further, the RA preamble group C may comprise beginning contention-free random access preambles or middle contention-free random access preambles or ending contention-free random access preambles.

In this case, the terminal device may determine an RA preamble group from the plurality of RA preamble groups based on the capability of PUSCH repetitions of the terminal device, and selects an RA preamble from the determined RA preamble group. Then the terminal device may transmit the RA preamble to the network node.

Additionally, in some embodiments, the RA preamble group C may comprise RA preamble group C1 and RA preamble group C2. In this case, the terminal device may determine an RA preamble group from the plurality of RA preamble groups based on the capability of PUSCH repetitions of the terminal device. If the determined RA preamble group is the RA preamble group C, the terminal device may determine whether a condition is satisfied. If the condition is satisfied, the terminal device may select the RA preamble group C1 and select an RA preamble from the RA preamble group C1. Otherwise, the terminal device may select the RA preamble group C2 and select an RA preamble from the RA preamble group C2. Then the terminal device may transmit the RA preamble to the network node.

In some embodiments, the condition may be at least one of the followings:
1) a size of the PUSCH transmission is below a third threshold;
2) a recommended number of repetitions is equal to or below a fourth threshold;
3) reference signal received power, RSRP, is below a fifth threshold;
4) the terminal device is in poor coverage or a cell border area; and
5) a camped synchronization signal/physical broadcast channel block, SSB, index is not the best SSB index.

Additionally, in some embodiments, the RA preamble group C may further comprise RA preamble group C3. In this case, when the terminal device cannot determine whether the condition is satisfied, the terminal device selects the RA preamble group C3 and select a RA preamble from the RA preamble group C3.

In some embodiments, prior to initiating the random access procedure, the terminal device may receive system information indicating one or more physical random access channel, PRACH, occasions to be used for a terminal device capable of supporting PUSCH repetition. In an embodiment, the one or more PRACH occasions are separately configured for the terminal device capable of supporting PUSCH repetition. In this case, the terminal device may determine a PRACH occasion based on the capability of PUSCH repetition of the terminal device, and determine an RA preamble associated with the determined PRACH occasion. Then the terminal device may transmit the RA preamble in the PRACH occasion to the network node.

Additionally, in some embodiments, a random access type, e.g. four-step RA type, may determined to be used for a terminal device capable of supporting PUSCH repetition. In this case, the terminal device may determine the random access type based on the capability of PUSCH repetition of the terminal device, and transmit the PRACH message according to the random access type.

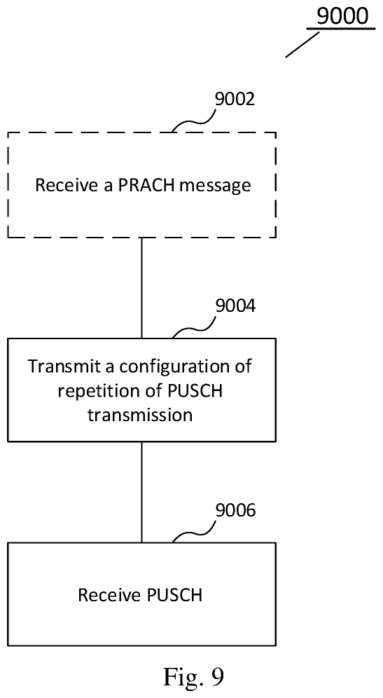

FIG. 9 is a flowchart illustrating a method 9000 according to some embodiments of the present disclosure. The method 9000 illustrated in FIG. 9 may be performed by an apparatus implemented in/as a network node or communicatively coupled to a network node. In accordance with an exemplary embodiment, the network node may be a gNB. In the following description with respect to FIG. 9, for the same or similar parts as those in the previous exemplary embodiments, the detailed description will be properly omitted.

According to the exemplary method 9000 illustrated in FIG. 9, the network node transmits the configuration of repetition of PUSCH transmission for a message in a random access procedure to the terminal device, as shown in block 9004. The message may be the message 3 in the four-step random access procedure. Then the network node receives a PUSCH from the terminal device, as shown in block 9006.

The details of the configuration of repetition of PUSCH transmission have been described above and will be omitted here.

In some embodiments, the network node may determine whether repetition is applied to the PUSCH transmission and/or the number of repetitions for the PUSCH transmission based on DMRS configuration used for PUSCH transmission.

In some embodiments, if the network node determines that the repetition is applied to the PUSCH transmission and the number of repetitions used by the terminal device for the PUSCH transmission is known to the network node, the network node may decode the PUSCH transmission with the number of repetitions. If the network node determines that the repetition is applied to the PUSCH transmission and the number of Msg3 repetitions used by the terminal device for the PUSCH transmission is not known to the network node, the network node may blindly decode the PUSCH transmission with repetition. If the network node determines that the repetition is not applied to the PUSCH transmission, the network node may decode the PUSCH transmission without repetition.

The mapping between application of repetition to the PUSCH transmission and DMRS configurations and the mapping between numbers of repetitions and DMRS configurations have been described above in detail, and will be omitted here.

Additionally, in some embodiments, the network node may receive a PRACH message from the terminal device, as shown in block 9002. In some embodiments, the PRACH message may indicate whether a capability of PUSCH repetition of the terminal device is indicated. The capability of PUSCH repetition is indicated by a RA preamble or a PRACH occasion used in the PRACH message. The details of how to indicate the capability of PUSCH repetitions in the PRACH message have been described above and will be omitted here.

In some embodiments, if the capability of PUSCH repetition of the terminal device indicates that the terminal device is capable of supporting PUSCH repetition, the network node may configure the number of repetitions for the terminal device based on the capability of PUSCH repetition of the terminal device. If the capability of PUSCH repetition of the terminal device indicates that the terminal device is incapable of supporting PUSCH repetition, the network node may not configure the number of repetitions for the terminal device. If the capability of PUSCH repetition of the terminal device is not indicated, the network node may blindly configure the number of repetitions for the terminal device. Then the network node may transmit the configuration of repetition comprising the configured number of repetitions to the terminal device.

The various blocks shown in FIGS. 8 and 9 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

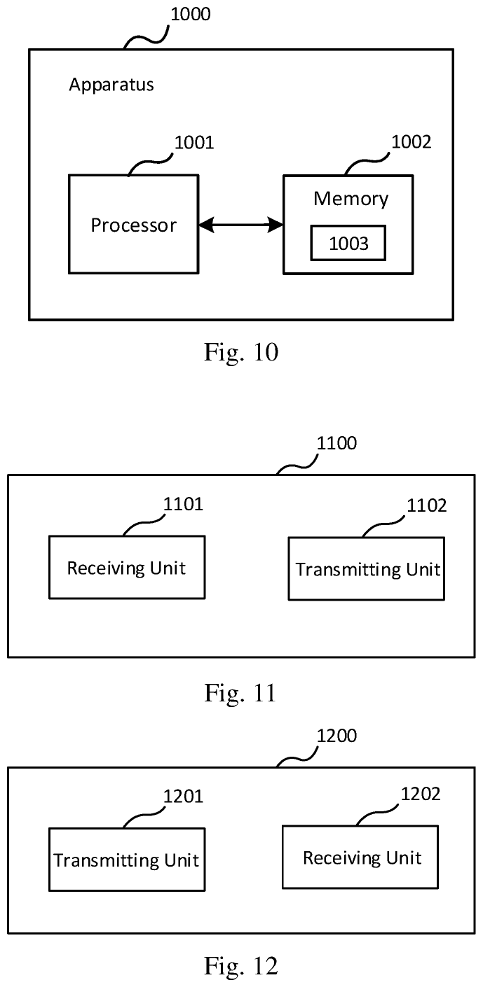

FIG. 10 is a block diagram illustrating an apparatus 1000 according to various embodiments of the present disclosure. As shown in FIG. 10, the apparatus 1000 may comprise one or more processors such as processor 1001 and one or more memories such as memory 1002 storing computer program codes 1003. The memory 1002 may be non-transitory machine/processor/computer readable storage medium. In accordance with some exemplary embodiments, the apparatus 1000 may be implemented as an integrated circuit chip or module that can be plugged or installed into a terminal device as described with respect to FIG. 8, or a network node as described with respect to FIG. 9.

In some implementations, the one or more memories 1002 and the computer program codes 1003 may be configured to, with the one or more processors 1001, cause the apparatus 1000 at least to perform any operation of the method as described in connection with FIG. 8. In such embodiments, the apparatus 1000 may be implemented as at least part of or communicatively coupled to the terminal device as described above. As a particular example, the apparatus 1000 may be implemented as a terminal device.

In other implementations, the one or more memories 1002 and the computer program codes 1003 may be configured to, with the one or more processors 1001, cause the apparatus 1000 at least to perform any operation of the method as described in connection with FIG. 9. In such embodiments, the apparatus 1000 may be implemented as at least part of or communicatively coupled to the network node as described above. As a particular example, the apparatus 1000 may be implemented as a network node.

Alternatively or additionally, the one or more memories 1002 and the computer program codes 1003 may be configured to, with the one or more processors 1001, cause the apparatus 1000 at least to perform more or less operations to implement the proposed methods according to the exemplary embodiments of the present disclosure.

FIG. 11 is a block diagram illustrating an apparatus 1100 according to some embodiments of the present disclosure. As shown in FIG. 11, the apparatus 1100 may comprise a receiving unit 1101 and a transmitting unit 1102. In an exemplary embodiment, the apparatus 1100 may be implemented in a terminal device such as a UE. The receiving unit 1101 may be operable to carry out the operation in block 804. The transmitting unit 1102 may be operable to carry out the operation in blocks 802 and 806. Optionally, the receiving unit 1101 and/or the transmitting unit 1102 may be operable to carry out more or less operations to implement the proposed methods according to the exemplary embodiments of the present disclosure.

FIG. 12 is a block diagram illustrating an apparatus 1200 according to some embodiments of the present disclosure. As shown in FIG. 12, the apparatus 1200 may comprise a transmitting unit 1201 and a receiving unit 1202. In an exemplary embodiment, the apparatus 1700 may be implemented in a network node such as a gNB. The transmitting unit 1201 may be operable to carry out the operation in block 904. The receiving unit 1202 may be operable to carry out the operation in blocks 902 and 906. Optionally, the transmitting unit 1201 and/or the receiving unit 1202 may be operable to carry out more or less operations to implement the proposed methods according to the exemplary embodiments of the present disclosure.

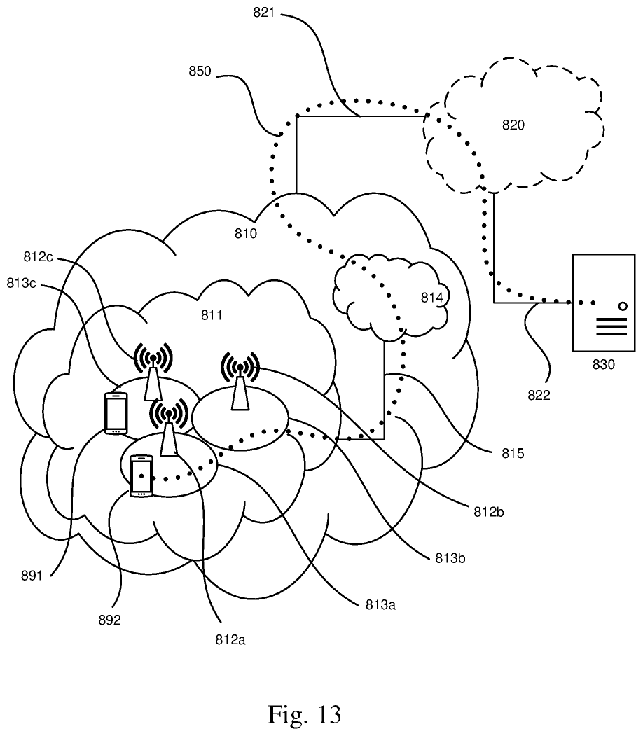

FIG. 13 is a block diagram illustrating a telecommunication network connected via an intermediate network to a host computer in accordance with some embodiments of the present disclosure.

With reference to FIG. 13, in accordance with an embodiment, a communication system includes a telecommunication network 810, such as a 3GPP-type cellular network, which comprises an access network 811, such as a radio access network, and a core network 814. The access network 811 comprises a plurality of base stations 812a, 812b, 812c, such as NBs, eNBs, gNBs or other types of wireless access points, each defining a corresponding coverage area 813a, 813b, 813c. Each base station 812a, 812b, 812c is connectable to the core network 814 over a wired or wireless connection 815. A first UE 891 located in a coverage area 813c is configured to wirelessly connect to, or be paged by, the corresponding base station 812c. A second UE 892 in a coverage area 813a is wirelessly connectable to the corresponding base station 812a. While a plurality of UEs 891, 892 are illustrated in this example, the disclosed embodiments are equally applicable to a situation where a sole UE is in the coverage area or where a sole UE is connecting to the corresponding base station 812.

The telecommunication network 810 is itself connected to a host computer 830, which may be embodied in the hardware and/or software of a standalone server, a cloud-implemented server, a distributed server or as processing resources in a server farm. The host computer 830 may be under the ownership or control of a service provider, or may be operated by the service provider or on behalf of the service provider. Connections 821 and 822 between the telecommunication network 810 and the host computer 830 may extend directly from the core network 814 to the host computer 830 or may go via an optional intermediate network 820. An intermediate network 820 may be one of, or a combination of more than one of, a public, private or hosted network; the intermediate network 820, if any, may be a backbone network or the Internet; in particular, the intermediate network 820 may comprise two or more sub-networks (not shown).

The communication system of FIG. 13 as a whole enables connectivity between the connected UEs 891, 892 and the host computer 830. The connectivity may be described as an over-the-top (OTT) connection 850. The host computer 830 and the connected UEs 891, 892 are configured to communicate data and/or signaling via the OTT connection 850, using the access network 811, the core network 814, any intermediate network 820 and possible further infrastructure (not shown) as intermediaries. The OTT connection 850 may be transparent in the sense that the participating communication devices through which the OTT connection 850 passes are unaware of routing of uplink and downlink communications. For example, the base station 812 may not or need not be informed about the past routing of an incoming downlink communication with data originating from the host computer 830 to be forwarded (e.g., handed over) to a connected UE 891. Similarly, the base station 812 need not be aware of the future routing of an outgoing uplink communication originating from the UE 891 towards the host computer 830.

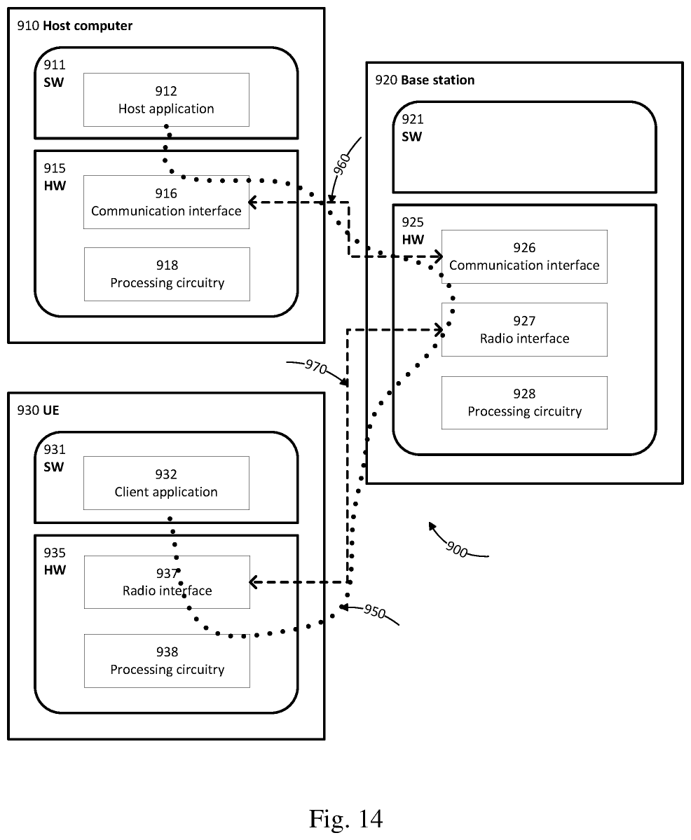

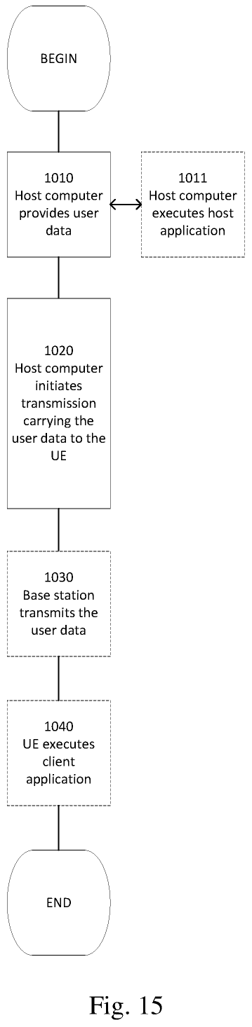

FIG. 14 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 14. In a communication system 900, a host computer 910 comprises hardware 915 including a communication interface 916 configured to set up and maintain a wired or wireless connection with an interface of a different communication device of the communication system 900. The host computer 910 further comprises a processing circuitry 918, which may have storage and/or processing capabilities. In particular, the processing circuitry 918 may comprise one or more programmable processors, application-specific integrated circuits, field programmable gate arrays or combinations of these (not shown) adapted to execute instructions. The host computer 910 further comprises software 911, which is stored in or accessible by the host computer 910 and executable by the processing circuitry 918. The software 911 includes a host application 912. The host application 912 may be operable to provide a service to a remote user, such as UE 930 connecting via an OTT connection 950 terminating at the UE 930 and the host computer 910. In providing the service to the remote user, the host application 912 may provide user data which is transmitted using the OTT connection 950.

The communication system 900 further includes a base station 920 provided in a telecommunication system and comprising hardware 925 enabling it to communicate with the host computer 910 and with the UE 930. The hardware 925 may include a communication interface 926 for setting up and maintaining a wired or wireless connection with an interface of a different communication device of the communication system 900, as well as a radio interface 927 for setting up and maintaining at least a wireless connection 970 with the UE 930 located in a coverage area (not shown in FIG. 14) served by the base station 920. The communication interface 926 may be configured to facilitate a connection 960 to the host computer 910. The connection 960 may be direct or it may pass through a core network (not shown in FIG. 14) of the telecommunication system and/or through one or more intermediate networks outside the telecommunication system. In the embodiment shown, the hardware 925 of the base station 920 further includes a processing circuitry 928, which may comprise one or more programmable processors, application-specific integrated circuits, field programmable gate arrays or combinations of these (not shown) adapted to execute instructions. The base station 920 further has software 921 stored internally or accessible via an external connection.

The communication system 900 further includes the UE 930 already referred to. Its hardware 935 may include a radio interface 937 configured to set up and maintain a wireless connection 970 with a base station serving a coverage area in which the UE 930 is currently located. The hardware 935 of the UE 930 further includes a processing circuitry 938, which may comprise one or more programmable processors, application-specific integrated circuits, field programmable gate arrays or combinations of these (not shown) adapted to execute instructions. The UE 930 further comprises software 931, which is stored in or accessible by the UE 930 and executable by the processing circuitry 938. The software 931 includes a client application 932. The client application 932 may be operable to provide a service to a human or non-human user via the UE 930, with the support of the host computer 910. In the host computer 910, an executing host application 912 may communicate with the executing client application 932 via the OTT connection 950 terminating at the UE 930 and the host computer 910. In providing the service to the user, the client application 932 may receive request data from the host application 912 and provide user data in response to the request data. The OTT connection 950 may transfer both the request data and the user data. The client application 932 may interact with the user to generate the user data that it provides.

It is noted that the host computer 910, the base station 920 and the UE 930 illustrated in FIG. 14 may be similar or identical to the host computer 830, one of base stations 812a, 812b, 812c and one of UEs 891, 892 of FIG. 13, respectively. This is to say, the inner workings of these entities may be as shown in FIG. 14 and independently, the surrounding network topology may be that of FIG. 13.

In FIG. 14, the OTT connection 950 has been drawn abstractly to illustrate the communication between the host computer 910 and the UE 930 via the base station 920, without explicit reference to any intermediary devices and the precise routing of messages via these devices. Network infrastructure may determine the routing, which it may be configured to hide from the UE 930 or from the service provider operating the host computer 910, or both. While the OTT connection 950 is active, the network infrastructure may further take decisions by which it dynamically changes the routing (e.g., on the basis of load balancing consideration or reconfiguration of the network).

Wireless connection 970 between the UE 930 and the base station 920 is in accordance with the teachings of the embodiments described throughout this disclosure. One or more of the various embodiments improve the performance of OTT services provided to the UE 930 using the OTT connection 950, in which the wireless connection 970 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 950 between the host computer 910 and the UE 930, in response to variations in the measurement results. The measurement procedure and/or the network functionality for reconfiguring the OTT connection 950 may be implemented in software 911 and hardware 915 of the host computer 910 or in software 931 and hardware 935 of the UE 930, or both. In embodiments, sensors (not shown) may be deployed in or in association with communication devices through which the OTT connection 950 passes; the sensors may participate in the measurement procedure by supplying values of the monitored quantities exemplified above, or supplying values of other physical quantities from which the software 911, 931 may compute or estimate the monitored quantities. The reconfiguring of the OTT connection 950 may include message format, retransmission settings, preferred routing etc.; the reconfiguring need not affect the base station 920, and it may be unknown or imperceptible to the base station 920. Such procedures and functionalities may be known and practiced in the art. In certain embodiments, measurements may involve proprietary UE signaling facilitating the host computer 910's measurements of throughput, propagation times, latency and the like. The measurements may be implemented in that the software 911 and 931 causes messages to be transmitted, in particular empty or ‘dummy’ messages, using the OTT connection 950 while it monitors propagation times, errors etc.

FIG. 15 is a flowchart illustrating a method implemented in a communication system, in accordance with an embodiment. The communication system includes a host computer, a base station and a UE which may be those described with reference to FIG. 13 and FIG. 14. For simplicity of the present disclosure, only drawing references to FIG. 15 will be included in this section. In step 1010, the host computer provides user data. In substep 1011 (which may be optional) of step 1010, the host computer provides the user data by executing a host application. In step 1020, the host computer initiates a transmission carrying the user data to the UE. In step 1030 (which may be optional), the base station transmits to the UE the user data which was carried in the transmission that the host computer initiated, in accordance with the teachings of the embodiments described throughout this disclosure. In step 1040 (which may also be optional), the UE executes a client application associated with the host application executed by the host computer.

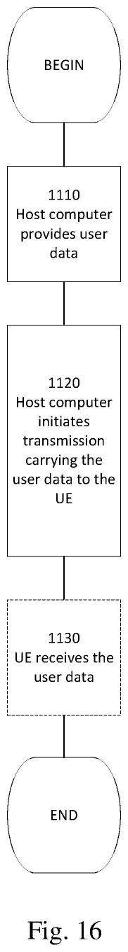

FIG. 16 is a flowchart illustrating a method implemented in a communication system, in accordance with an embodiment. The communication system includes a host computer, a base station and a UE which may be those described with reference to FIG. 13 and FIG. 14. For simplicity of the present disclosure, only drawing references to FIG. 16 will be included in this section. In step 1110 of the method, the host computer provides user data. In an optional substep (not shown) the host computer provides the user data by executing a host application. In step 1120, the host computer initiates a transmission carrying the user data to the UE. The transmission may pass via the base station, in accordance with the teachings of the embodiments described throughout this disclosure. In step 1130 (which may be optional), the UE receives the user data carried in the transmission.

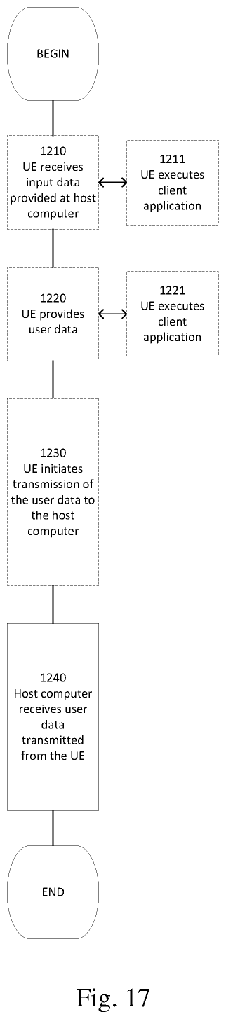

FIG. 17 is a flowchart illustrating a method implemented in a communication system, in accordance with an embodiment. The communication system includes a host computer, a base station and a UE which may be those described with reference to FIG. 13 and FIG. 14. For simplicity of the present disclosure, only drawing references to FIG. 17 will be included in this section. In step 1210 (which may be optional), the UE receives input data provided by the host computer. Additionally or alternatively, in step 1220, the UE provides user data. In substep 1221 (which may be optional) of step 1220, the UE provides the user data by executing a client application. In substep 1211 (which may be optional) of step 1210, the UE executes a client application which provides the user data in reaction to the received input data provided by the host computer. In providing the user data, the executed client application may further consider user input received from the user. Regardless of the specific manner in which the user data was provided, the UE initiates, in substep 1230 (which may be optional), transmission of the user data to the host computer. In step 1240 of the method, the host computer receives the user data transmitted from the UE, in accordance with the teachings of the embodiments described throughout this disclosure.

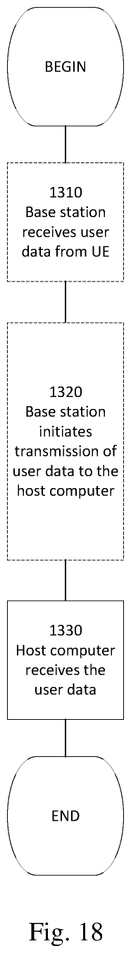

FIG. 18 is a flowchart illustrating a method implemented in a communication system, in accordance with an embodiment. The communication system includes a host computer, a base station and a UE which may be those described with reference to FIG. 13 and FIG. 14. For simplicity of the present disclosure, only drawing references to FIG. 18 will be included in this section. In step 1310 (which may be optional), in accordance with the teachings of the embodiments described throughout this disclosure, the base station receives user data from the UE. In step 1320 (which may be optional), the base station initiates transmission of the received user data to the host computer. In step 1330 (which may be optional), the host computer receives the user data carried in the transmission initiated by the base station.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

What is claimed is:

1. A method (800) implemented at a terminal device comprising:
receiving (804) a configuration of repetition of physical uplink shared channel, PUSCH, transmission for a message in a random access procedure from a network node; and
transmitting (806) a PUSCH to the network node, based on the configuration of repetition of PUSCH transmission.

2. The method according to claim 1, wherein the message is a message 3 in a four-step random access procedure.

3. The method according to claim 1 or 2, wherein the configuration of repetition of PUSCH transmission is received in a random access response, RAR.

4. The method according to claim 3, wherein the configuration of repetition of PUSCH transmission comprises a configured number of repetitions.

5. The method according to claim 4, wherein the configured number of repetitions is one of the followings: a specific number of repetitions, and a maximum number of repetitions.

6. The method according to claim 1 or 2, wherein the configuration of repetition of PUSCH transmission is received in system information.

7. The method according to claim 6, wherein the configuration of repetition of PUSCH transmission is indicated in PUSCH-ConfigCommon information element in system information block1, SIB1, or is jointly encoded in a time domain resource allocation table in SIB1.

8. The method according to claim 6 or 7, wherein the configuration of repetition of PUSCH transmission comprises at least one of the followings: one or more candidate numbers of repetitions, a default number of repetitions, and a maximum number of repetitions.

9. The method according to claim 1 or 2, wherein the configuration of repetition of PUSCH transmission is received in downlink control information, DCI.

10. The method according to claim 9, wherein the configuration of repetition of PUSCH transmission comprises a specific number of repetitions or a maximum number of repetitions.

11. The method according to claim 1 or 2, wherein the configuration of repetition of PUSCH transmission comprises information related to determination of available slots for the repetition of PUSCH transmission.

12. The method according to claim 11, wherein the information related to determination of available slots for the repetition of PUSCH transmission indicates which slot is an available slot for the repetition, or indicates whether and which Time Division Duplexing, TDD, uplink downlink signaling is to be used for the determination of available slots.

13. The method according to claim 11 or 12, wherein the information related to determination of available slots for the repetition of PUSCH transmission is included in at least one of the followings:
a cell specific TDD uplink downlink configuration, a random access response, RAR, and downlink control information, DCI.

14. The method according to any one of claims 11 to 13, wherein the available slot is a slot not configured as a downlink slot, and/or a slot in which a set of symbols allocated for the repetition of PUSCH transmission is not configured as downlink, and/or a slot configured as an uplink slot, and/or a slot in which a set of symbols allocated for the repetition of PUSCH transmission is configured as uplink.

15. The method according to any one of claims 11 to 14, wherein the configuration of repetition of PUSCH transmission further comprises priority information for collision handling between the repetition of PUSCH transmission and other uplink transmission from the terminal device.

16. The method according to claim 15, wherein the priority information is included in a higher layer configuration and/or DCI, and/or is predetermined or predefined.

17. The method according to claim 15 or 16, wherein the priority information is based on a time order of scheduling signaling, or a content of uplink transmission, or a type of scheduling signaling.

18. The method according to any one of claims 15 to 17, wherein the collision handling is based on the priority information received prior to transmission of the first repetition of PUSCH transmission.

19. The method according to claim 18, wherein the collision handling is further based on the priority information received during transmission of the repetitions of PUSCH transmission.

20. The method according to any one of claims 1 to 19, wherein transmitting the PUSCH to the network node based on the configuration of repetition of PUSCH transmission comprises:
determining a number of repetitions to be used for the PUSCH transmission based on the configuration of repetition of PUSCH transmission; and
transmitting the PUSCH based on the determined number of repetitions.

21. The method according to claim 20, wherein the configuration of repetition of PUSCH transmission is received in the RAR or DCI, and
wherein determining a number of repetitions to be used for the PUSCH transmission comprises:
when the configuration of repetition of PUSCH transmission comprises the specific number of repetitions, determining the number of repetitions to be the specific number of repetitions; and/or
when the configuration of repetition of PUSCH transmission comprises the maximum number of repetitions, determining the number of repetitions to be a number not more than the maximum number of repetitions.

22. The method according to claim 20, wherein the configuration of repetition of PUSCH transmission is received in the system information and not received in the RAR or DCI; and
wherein determining a number of repetitions to be used for the PUSCH transmission comprises:
when the configuration of repetition of PUSCH transmission comprises only one or more candidate number of repetitions, choosing a candidate number of repetitions from the one or more candidate numbers of repetitions, as the number of repetitions to be used for the PUSCH transmission; and/or
when the configuration of repetitions of PUSCH transmission comprises the default number of repetitions or both the default number of repetitions and the maximum number of repetitions, determining the number of repetitions to be the default number of repetitions; and/or
when the configuration of repetitions of PUSCH transmission comprises the maximum number of repetitions, determining the number of repetitions to be a number not more than the maximum number of repetitions.

23. The method according to claim 20, wherein when the configuration of repetition of PUSCH transmission is jointly encoded in a time domain resource allocation table in SIB1, an entry of the time domain resource allocation table is received in the RAR or DCI, and wherein the number of repetitions to be used for the PUSCH transmission is determined based on the entry.

24. The method according to claim 20, wherein transmitting the PUSCH to the network node based on the configuration of repetition of PUSCH transmission further comprises:
determining respective available slots for the number of repetitions, based on the information related to determination of available slots for the repetition of PUSCH transmission included in the configuration of repetition of PUSCH transmission; and
wherein the PUSCH is transmitted in the respective available slots.

25. The method according to claim 24, wherein the random access procedure is contention based random access, CBRA, and the available slots are determined based on a cell specific TDD uplink downlink configuration.

26. The method according to claim 24, wherein the random access procedure is contention free random access, CFRA, and the available slots are determined based on a dedicated TDD uplink downlink configuration and/or a cell specific TDD uplink downlink configuration.

27. The method according to any one of claims 24 to 26, wherein the available slots are determined further based on collision with other uplink transmission from the terminal device and/or a cancellation indication.

28. The method according to any one of claims 24 to 27, wherein an available slot is determined as unavailable if at least one of a set of symbols allocated for the repetition of PUSCH transmission in that available slot overlaps with a symbol not intended for an uplink transmission.

29. The method according to any one of claims 24 to 28, wherein the available slots are determined prior to transmission of the first repetition of PUSCH transmission and/or during transmission of the repetitions of PUSCH transmission.

30. The method according to any one of claims 24 to 29, wherein redundancy versions for the repetitions of PUSCH transmission are cycled across the determined available slots.

31. The method according to any one of claims 24 to 29, wherein redundancy versions for the repetitions of PUSCH transmission are cycled across the transmitted repetitions of PUSCH transmission.

32. The method according to any one of claims 20 to 23, wherein transmitting the PUSCH comprises:
determining one or more slots among K slots from a first slot for the repetitions to be used for repetitions of PUSCH transmission, wherein K represents the determined number of repetitions;
for each slot of the K slots in which all L scheduled uplink, UL, symbols for PUSCH transmission are available,
transmitting a repetition by configuring the L scheduled UL symbols and placing demodulation reference signal, DMRS, in the slot; and/or
for each slot in which part of the L scheduled UL symbols is available of the K slots,
when a number of the available UL symbols is not less than a first threshold, performing a symbol-wise repetition from a particular repetition which has the L scheduled UL symbols available on the available UL symbols and placing DMRS in the slot; and/or
when the number of the available UL symbols is less than the first threshold, not using the slot to transmit the PUSCH.

33. The method according to any one of claims 20 to 23, wherein transmitting the PUSCH comprises:
for a slot from a first slot for repetitions of PUSCH transmission,
when all L scheduled UL symbols for PUSCH transmission are available,
transmitting a repetition by configuring the L scheduled UL symbols and placing DMRS in the slot; and
incrementing a slot counter; and/or
when part of the L scheduled UL symbols is available,
when a number of the available UL symbols is not less than a first threshold, performing a symbol-wise repetition from a particular repetition which has the L scheduled UL symbols available on the available UL symbols and placing DMRS in the slot; and/or
when the number of the available UL symbols is less than the first threshold, not using the slot to transmit the PUSCH; and
repeating the above operations for a next slot until the slot counter reaches the determined number of repetitions.

34. The method according to claim 32 or 33, wherein the placement of the DMRS in the slot is configured or predefined.

35. The method according to any one of claims 32 to 34, wherein the particular repetition is determined further based on redundancy version cycling.

36. The method according to any one of claims 32 to 35, wherein the first threshold is transmitted via radio resource control, RRC, signaling or downlink control information, DCI, or the first threshold is predefined.

37. The method according to any one of claims 24 to 36, wherein the slots for the repetitions of PUSCH transmission are contiguous or non-contiguous within one radio frame or across frame border.

38. The method according to claim 37, further comprising:
transmitting a capability report indicating a capability of keeping phase coherency across multiple slots to the network node.

39. The method according to any one of claims 24 to 38, wherein transmitting the PUSCH further comprises: for each of the slots for the repetitions of PUSCH transmission,
checking whether a dynamic slot format indicator is configured for the slot;
in response to the dynamic slot format indicator being not configured,
determining whether semi-static flexible symbols are available for PUSCH transmission; and/or
in response to the dynamic slot format indicator being configured,
determining whether semi-static flexible symbols are changed as DL symbols; and
determining the semi-static flexible symbols changed as the DL symbols are unavailable for PUSCH transmission.

40. The method according to any one of claims 24 to 39, wherein transmitting the PUSCH further comprises: for each slot of the slots in which part of the L scheduled UL symbols is available,
applying frequency hopping to the repetition in the slot when the number of the available UL symbols of the L scheduled UL symbols is not less than a second threshold; and/or
applying no frequency hopping to the repetition in the slot when the number of the available UL symbols of the L scheduled UL symbols is less than the second threshold.

41. The method according to any one of claims 1 to 40, wherein a DMRS configuration for the DMRS is determined based on at least one of application of repetition to PUSCH transmission and the number of repetitions to be used for the PUSCH transmission.

42. The method according to claim 41, wherein a mapping between application of repetition and DMRS configurations and a mapping between numbers of repetitions and DMRS configurations are configured or predefined.

43. The method according to claim 41 or 42, wherein the application of repetition is mapped to at least one of the followings in the DMRS configuration: a DMRS port, a code division multiplexing, CDM, group, a DMRS configuration type, usage of an additional DMRS symbol, and a DMRS sequence.

44. The method according to claim 41 or 42, wherein the number of repetitions is mapped to at least one of the followings in the DMRS configuration: a DMRS port, a DMRS configuration type, a CDM group, and a DMRS sequence.

45. The method according to any one of claims 1 to 44, further comprising:
transmitting (802) a physical random access channel, PRACH, message to the network node, wherein the PRACH message indicates a capability of PUSCH repetition of the terminal device.

46. The method according to claim 45, wherein the capability of PUSCH repetition is indicated by a random access, RA, preamble or a PRACH occasion used in the PRACH message.

47. The method according to claim 45 or 46, further comprising:
receiving system information indicating a plurality of RA preamble groups and one or more of the plurality of RA preamble groups to be used for a terminal device capable of supporting PUSCH repetition.

48. The method according to claim 47, wherein the plurality of RA preamble groups comprises RA preamble group A and RA preamble group B, and the RA preamble group B is configured to be used for a terminal device capable of supporting PUSCH repetition.

49. The method according to claim 47, wherein the plurality of RA preamble groups comprises RA preamble group A, RA preamble group B and RA preamble group C, and the RA preamble group C is configured to be used for a terminal device capable of supporting PUSCH repetition.

50. The method according to claim 49, wherein the RA preamble group C comprises a subset of contention-free random access preambles and is configured as contention based random access preambles.

51. The method according to claim 50, wherein the RA preamble group C comprises beginning contention-free random access preambles or middle contention-free random access preambles or ending contention-free random access preambles.

52. The method according to any one of claims 47 to 51, wherein transmitting the PRACH message comprises:
determining an RA preamble group from the plurality of RA preamble groups based on the capability of PUSCH repetitions of the terminal device;
selecting an RA preamble from the determined RA preamble group; and
transmitting the RA preamble to the network node.

53. The method according to any one of claims 49 to 52, wherein the RA preamble group C comprises RA preamble group C1 and RA preamble group C2.

54. The method according to claim 53, wherein transmitting the PRACH message comprises:
determining an RA preamble group from the plurality of RA preamble groups based on the capability of PUSCH repetitions of the terminal device;
in response to the determined RA preamble group being the RA preamble group C, determining whether a condition is satisfied;
in response to the condition being satisfied,
selecting the RA preamble group C1; and
selecting an RA preamble from the RA preamble group C1; and/or
in response to the condition being not satisfied,
selecting the RA preamble group C2; and
selecting an RA preamble from the RA preamble group C2; and
transmitting the RA preamble to the network node.

55. The method according to claim 54, wherein the condition is at least one of the followings:
1) a size of the PUSCH transmission is below a third threshold;
2) a recommended number of repetitions is equal to or below a fourth threshold;
3) reference signal received power, RSRP, is below a fifth threshold;
4) the terminal device is in poor coverage or a cell border area; and
5) a camped synchronization signal/physical broadcast channel block, SSB, index is not the best SSB index.

56. The method according to any one of claims 53 to 55, wherein the RA preamble group C further comprises RA preamble group C3.

57. The method according to claim 56, wherein when the terminal device cannot determine whether the condition is satisfied, the RA preamble group C3 is selected, and a RA preamble is selected from the RA preamble group C3.

58. The method according to any one of claim 45 or 46, further comprising:
receiving system information indicating one or more physical random access channel, PRACH, occasions to be used for a terminal device capable of supporting PUSCH repetition.

59. The method according to claim 58, wherein the one or more PRACH occasions are separately configured for the terminal device capable of supporting PUSCH repetition.

60. The method according to claim 58 or 59, wherein transmitting the PRACH message comprises:
determining a PRACH occasion based on the capability of PUSCH repetition of the terminal device;
determining an RA preamble; and
transmitting the RA preamble in the PRACH occasion to the network node.

61. The method according to claims 1 to 60, wherein a random access type is determined to be used for a terminal device capable of supporting PUSCH repetition.

62. The method according to claim 61, wherein transmitting the PRACH message comprises:
determining a random access type based on the capability of PUSCH repetition of the terminal device; and
transmitting the PRACH message according to the random access type.

63. A terminal device (1000) comprising:
one or more processors (1001); and
one or more memories (1002) comprising computer program codes (1003),
the one or more memories (1002) and the computer program codes (1003) configured to, with the one or more processors (1003), cause the terminal device (1000) to:
receive a configuration of repetition of physical uplink shared channel, PUSCH, transmission for a message in a random access procedure from a network node; and
transmit a PUSCH to the network node, based on the configuration of repetition of PUSCH transmission.

64. The terminal device (1000) according to claim 63, wherein the one or more memories (1002) and the computer program codes (1003) are further configured to, with the one or more processors (1001), cause the terminal device (1000) to perform the method according to any one of claims 2-62.

65. A computer-readable medium having computer program codes embodied thereon which, when executed on a computer, cause the computer to perform the method according to any one of claims 1-62.

66. A method (9000) implemented at a network node, comprising:
transmitting (9004) a configuration of repetition of physical uplink shared channel, PUSCH, transmission for a message in a random access procedure to a terminal device; and
receiving (9006) a PUSCH from the terminal device.

67. The method according to claim 66, wherein the message is a message 3 in a four-step random access procedure.

68. The method according to claim 66 or 67, wherein the configuration of repetition of PUSCH transmission is transmitted in a random access response, RAR.

69. The method according to claim 68, wherein the configuration of repetition of PUSCH transmission comprises a configured number of repetitions.

70. The method according to claim 69, wherein the configured number of repetitions is one of the followings: a specific number of repetitions, and a maximum number of repetitions.

71. The method according to claim 66 or 67, wherein the configuration of repetition of PUSCH transmission is transmitted in system information.

72. The method according to claim 71, wherein the configuration of repetition of PUSCH transmission is indicated in PUSCH-ConfigCommon information element in system information block1, SIB1, or is jointly encoded in a time domain resource allocation table in SIB1.

73. The method according to claim 72, wherein the configuration of repetition of PUSCH transmission comprises at least one of the followings: one or more candidate numbers of repetitions, a default number of repetitions, and a maximum number of repetitions.

74. The method according to claim 66 or 67, wherein the configuration of repetition of PUSCH transmission is transmitted in downlink control information, DCI.

75. The method according to claim 74, wherein the configuration of repetition of PUSCH transmission comprises a specific number of repetitions or a maximum number of repetitions.

76. The method according to claim 72, wherein when the configuration of repetition of PUSCH transmission is jointly encoded in a time domain resource allocation table in SIB1, an entry of the time domain resource allocation table is transmitted in the RAR or DCI.

77. The method according to claim 66 or 67, wherein the configuration of repetition of PUSCH transmission comprises information related to determination of available slots for the repetition of PUSCH transmission.

78. The method according to claim 77, wherein the information related to determination of available slots for the repetition of PUSCH transmission indicates which slot is an available slot for the repetition, or indicates whether and which Time Division Duplexing, TDD, uplink downlink signaling is to be used for the determination of available slots.

79. The method according to claim 77 or 78, wherein the information related to determination of available slots for the repetition of PUSCH transmission is included in at least one of the followings: a cell specific TDD uplink downlink configuration, a random access response, RAR, and downlink control information, DCI.

80. The method according to any one of claims 77 to 79, wherein the available slot is a slot not configured as a downlink slot, and/or a slot in which a set of symbols allocated for the repetition of PUSCH transmission is not configured as downlink, and/or a slot configured as an uplink slot, and/or a slot in which a set of symbols allocated for the repetition of PUSCH transmission is configured as uplink.

81. The method according to any one of claims 77 to 80, wherein the configuration of repetition of PUSCH transmission further comprises priority information for collision handling between the repetition of PUSCH transmission and other uplink transmission from the terminal device.

82. The method according to claim 81, wherein the priority information is included in a higher layer configuration and/or DCI, and/or is predetermined or predefined.

83. The method according to claim 81 or 82, wherein the priority information is based on a time order of scheduling signaling, or a content of uplink transmission, or a type of scheduling signaling.

84. The method according to any one of claims 66 to 83, wherein redundancy versions for the repetitions of PUSCH transmission are cycled across the determined available slots.

85. The method according to any one of claims 66 to 83, wherein redundancy versions for the repetitions of PUSCH transmission are cycled across the transmitted repetitions of PUSCH transmission.

86. The method according to any one of claims 66 to 85, wherein receiving the PUSCH from the terminal device comprises:
determining whether repetition is applied to the PUSCH transmission based on a demodulation reference signal, DMRS, configuration used for PUSCH transmission; and
in response to determining that the repetition is applied to the PUSCH transmission,
when a number of repetitions used by the terminal device for the PUSCH transmission is known to the network node, decoding the PUSCH transmission with the number of repetitions; and/or
when the number of Msg3 repetitions used by the terminal device for the PUSCH transmission is not known to the network node, blindly decoding the PUSCH transmission with repetition; and/or
in response to determining that the repetition is not applied to the PUSCH transmission, decoding the PUSCH transmission without repetition.

87. The method according to any one of claims 66 to 86, wherein the determination of whether repetition is applied to the PUSCH transmission is based on at least one of the followings in the DMRS configuration: a DMRS port, a code division multiplexing, CDM, group, a DMRS configuration type, usage of an additional DMRS symbol, and a DMRS sequence.

88. The method according to claim 87, wherein a mapping between application of repetition and DMRS configurations is configured or predefined.

89. The method according to any one of claims 86 to 88, wherein when the number of repetitions used by the terminal device for the PUSCH transmission is not known to the network node, receiving the PUSCH from the terminal device further comprises:
determining the number of repetitions used by the terminal device for the PUSCH transmission based on the DMRS configuration.

90. The method according to claim 89, wherein the determination of the number of repetitions is based on at least one of the followings in the DMRS configuration: a DMRS port, a DMRS configuration type, a CDM group, and a DMRS sequence.

91. The method according to claim 89 or 90, wherein a mapping between numbers of repetitions and DMRS configurations is configured or predefined.

92. The method according to any one of claims 66 to 91, further comprising:
receiving (9002) a PRACH message from the terminal device, wherein the PRACH message indicates whether a capability of PUSCH repetition of the terminal device is indicated.

93. The method according to claim 92, wherein the capability of PUSCH repetition is indicated by a random access, RA, preamble or a PRACH occasion used in the PRACH message.

94. The method according to claim 92 or 93, wherein transmitting a configuration of repetition of PUSCH transmission comprises:
determining whether the capability of PUSCH repetition of the terminal device is indicated based on the PRACH message;
when the capability of PUSCH repetition of the terminal device indicates that the terminal device is capable of supporting PUSCH repetition, configuring the number of repetitions for the terminal device based on the capability of PUSCH repetition of the terminal device; and/or
when the capability of PUSCH repetition of the terminal device indicates that the terminal device is incapable of supporting PUSCH repetition, not configuring the number of repetitions for the terminal device; and/or
when the capability of PUSCH repetition of the terminal device is not indicated, blindly configuring the number of repetitions for the terminal device; and
transmitting the configuration of repetition comprising the configured number of repetitions.

95. The method according to any one of claims 92 to 94, further comprising:
transmitting system information indicating a plurality of RA preamble groups and one or more of the plurality of RA preamble groups to be used for a terminal device capable of supporting PUSCH repetition.

96. The method according to claim 95, wherein the plurality of RA preamble groups comprises RA preamble group A and RA preamble group B, and the RA preamble group B is configured to be used for a terminal device capable of supporting PUSCH repetition.

97. The method according to claim 95, wherein the plurality of RA preamble groups comprises RA preamble group A, RA preamble group B and RA preamble group C, and the RA preamble group C is configured to be used for a terminal device capable of supporting PUSCH repetition.

98. The method according to claim 97, wherein the RA preamble group C comprises a subset of contention-free random access preambles and is configured as contention based random access preambles.

99. The method according to claim 98, wherein the RA preamble group C comprises beginning contention-free random access preambles or middle contention-free random access preambles or ending contention-free random access preambles.

100. The method according to any one of claims 97 to 99, wherein the RA preamble group C comprises RA preamble group C1 further configured to be used for a terminal device satisfying a condition and RA preamble group C2 further configured to be used for a terminal device not satisfying the condition.

101. The method according to claim 100, wherein the RA preamble group C further comprises RA preamble group C3 further configured to be used for a terminal device which does not determine whether the condition is satisfied.

102. The method according to claim 100 or 101, wherein the condition is one of the followings:
1) a size of the PUSCH transmission is below a third threshold;
2) a recommended number of repetitions is equal to or below a fourth threshold;
3) reference signal received power, RSRP, is below a fifth threshold;
4) the terminal device is in poor coverage or a cell border area; and
5) a camped synchronization signal/physical broadcast channel block, SSB, index is not the best SSB index.

103. The method according to any one of claims 94 to 102, wherein determining whether the capability of PUSCH repetition of the terminal device is indicated based on the PRACH message comprises:
obtaining a random access, RA, preamble in PRACH message;
determining an RA preamble group associated with the RA preamble; and
determining whether the capability of PUSCH repetition of the terminal device is indicated based on the determined RA preamble group.

104. The method according to any one of claims 92 to 94, further comprising:
transmitting system information indicating one or more physical random access channel, PRACH, occasions to be used for a terminal device capable of supporting PUSCH repetition.

105. The method according to claim 104, wherein the one or more PRACH occasions are separately configured for the terminal device capable of supporting PUSCH repetition.

106. The method according to claim 104 or 105, wherein determining whether the capability of PUSCH repetition of the terminal device is indicated based on the PRACH message comprises:
determining a PRACH occasion in which an RA preamble is transmitted; and
determining whether the capability of Msg3 repetition of the terminal device is indicated based on the determined PRACH occasion.

107. The method according to any one of claims 66 to 94, wherein a random access type is determined to be used for a terminal device capable of supporting PUSCH repetition.

108. The method according to claim 107, wherein determining whether the capability of PUSCH repetition of the terminal device is indicated based on the PRACH message comprises:
determining a random access type based on an RA preamble transmitted in the PRACH message; and
determining whether the capability of PUSCH repetition of the terminal device is indicated based on the random access type.

109. A network node (1000) in a communication network comprising:
one or more processors (1001); and
one or more memories (1002) comprising computer program codes (1003),
the one or more memories (1002) and the computer program codes (1003) configured to, with the one or more processors (1001), cause the network node (1000) to:
transmit a configuration of repetition of physical uplink shared channel, PUSCH, transmission for a message in a random access procedure; and
receiving a PUSCH from the terminal device.

110. The network node (1000) according to claim 109, wherein the one or more memories (1002) and the computer program codes (1003) are further configured to, with the one or more processors (1001), cause the network node (1000) to perform the method according to any one of claims 67-108.

111. A computer-readable medium having computer program codes embodied thereon which, when executed on a computer, cause the computer to perform the method according to any one of claims 66-108.
